(19) United States
(12) Patent Application Publication
(10) Pub. No.: US 2008/0056786 A1
(43) Pub. Date: Mar. 6, 2008

(54) Image forming apparatus and image forming method

(76) Inventors: Masahito Ishino, Osaka (JP); Chikara Ishihara, Osaka (JP); Yuki Matsui, Osaka (JP); Katsuya Ota, Osaka (JP); Norio Tomiie, Osaka (JP)

Correspondence Address: ARTHUR G. SCHAIER;CARMODY & TORRANCE LLP, 50 LEAVENWORTH STREET, P.O. BOX 1110, WATERBURY, CT, 06721, US

(21) Appl. No.: 11/895,949

(22) Filed: Aug. 28, 2007

(30) Foreign Application Priority Data
Aug. 30, 2006 (JP) 2006-234138

(51) Int. Cl. G03G 21/00

(52) U.S. Cl. 399/357

(57) ABSTRACT

The invention provides an image forming apparatus that, even when a downward transfer method is adopted, can prevent a toner in a cleaning device from excessively charging and an air gap from occurring, and thereby can effectively suppress occurrence of black spots due to a leakage current from the cleaning device, and an image forming method therewith. Provided are an image forming apparatus includes a latent image carrier for transferring a toner carried on a surface thereof from downward to a transfer body; and a cleaning device provided with a rotation member for cleaning the surface of the latent image carrier, a resistance of an elastic layer formed on an outer periphery part of the rotation member being set to a value in the range of 1×10² to 1×10⁷Ω, and an image forming method.

### BACKGROUND OF THE INVENTION

1. Field of the Invention

The present invention relates to an image forming apparatus and an image forming method thereof. In particular, the invention relates to an image forming apparatus that, even when a downward transfer process is adopted, can effectively prevent occurrence of black spots due to a leakage current from a cleaning device, and an image forming method therewith.

2. Description of the Related Art

Conventionally, in an image forming method based on an electrophotographic process that uses a copying machine or a printer as such, an electrophotographic photoconductor (photoconductor drum) is widely used as a latent image carrier. A general image forming method that uses such an electrophotographic photoconductor is carried out as follows.

That is, a surface of an electrophotographic photoconductor is charged to a predetermined potential by using a charging means, followed by illuminating light from a LED light source by using a exposure means to optically attenuate the potential of an exposed part to form an electrostatic latent image corresponding to an original image. Next, the electrostatic latent image is developed by using a developing means to form a toner image on a surface of an electrophotographic photoconductor. Finally, the electrophotographic photoconductor is brought into contact with or closer to the transfer means to transfer the toner image on an intermediate transfer body or paper.

In such an image forming method, on the other hand, a problem is found that, on the surface of the electrophotographic photoconductor after the transfer, a toner that does not take part in the image formation, which is called a residual toner, tends to remain. Furthermore, when an amorphous silicon photoconductor is used as an electrophotographic photoconductor, a problem is found that, owing to the discharge means, foreign matters such as discharge products tend to stick to the surface of the electrophotographic photoconductor.

In this connection, in order to overcome such problems, there is proposed a method in which, in addition to adding a slight amount of a polishing agent to a toner to be used, a polishing roller and a cleaning blade are used together to remove a residual toner and foreign matters such as discharge products on a surface of an electrophotographic photoconductor (for example, Patent Documents 1 and 2).

More specifically, Patent Document 1 discloses an image forming method where, with a toner containing a polishing agent and an amorphous silicon drum as a photoconductor, the toner is developed by using a developing means and transferred, and a surface of the amorphous silicon drum is polished and cleaned by a slide friction roller. In this method, an elastic layer that captures the polishing agent is provided on a surface of the slide friction roller to capture the polishing agent in the toner by the elastic layer, and the captured polishing agent polishes and cleanses a drum surface.

On the other hand, Patent Document 2 discloses an image forming apparatus that includes a photoconductor; a slide friction roller that friction slides on a surface of the photoconductor through a toner; a scraping member that scrapes the toner off the surface of the photoconductor; and toner transfer means for transferring the toner scraped by the scraping member in parallel along an axial direction of the slide friction roller, wherein a toner transfer rate at an intermediate part in the axial direction of the slide friction roller is set slower in the speed than a transfer rate in both end parts in the axial direction of the slide friction roller.

### [Patent Document 1] JP10-63157A (claims and FIG. 1)

### [Patent Document 2] JP2005-49620A (claims and FIG. 1)

However, in the image forming methods described in Patent Documents 1 and 2, charging of the toner in the cleaning device is not particularly considered. Accordingly, a toner stored in the cleaning device tends to be charged excessively owing to friction with a cleaning blade or a polishing roller. As a result, a phenomenon is found that charges accumulated in the toner in the neighborhood of the cleaning blade abruptly discharge to be a leakage current to flow toward the surface of the electrophotographic photoconductor, is found.

Accordingly, there is a problem that owing to such a leakage current, the surface of the electrophotographic photoconductor is damaged to generate a black spot in a formed image.

In particular, in a case of adopting a method where a toner carried on a surface of an electrostatic latent image carrier is transferred from downward to a transfer body (hereinafter, in some cases, referred to as a downward transfer method), the toner stored in the cleaning device, and the polishing roller and the electrophotographic photoconductor are always in contact under friction: accordingly, excessive charging in such a toner tends to remarkably appear.

When adopting such a downward transfer method, observed is a phenomenon that an air gap that may cause the abrupt discharge tends to occur between the toner in the neighborhood of the cleaning blade and the surface of the electrophotographic photoconductor. Accordingly, there is a problem that, owing to charges accumulated in the toner in the neighborhood of the cleaning blade, a leakage current more tends to occur to further increase black spots.

### SUMMARY OF THE INVENTION

In view of this situation, the inventors of the present invention have made earnest studies concerning the above problems, and as a result, found that, in the case of the downward transfer method being adopted, use of a rotation member provided with an elastic layer having a predetermined resistance makes it possible to effectively inhibit the excessive charging of the toner in the cleaning device and generation of an air gap, thereby to complete the present invention.

That is, an object of the present invention is to provide an image forming apparatus that, even when a downward transfer method is adopted, can prevent a toner in a cleaning device and an air gap from excessively charging and thereby can effectively prevent black spots due to a leakage current from the cleaning device from occurring, and an image forming method therewith.

According to one aspect of the invention, there is provided an image forming apparatus that comprises a latent image carrier for transferring a toner carried on a surface thereof from downward to a transfer body; and a cleaning device provided with a rotation member for cleaning the surface of the latent image carrier, wherein a resistance of an elastic layer formed on an outer periphery part of the rotation member is set to a value in the range of 1×10² to 1×10⁷Ω, and therefore, the foregoing problems can be solved.

That is, even when the downward transfer method is adopted, the resistance of the elastic body formed on the outer periphery part of the rotation member is set within a predetermined range, so that the toner in the cleaning device can be effectively inhibit the excessive charging.

Furthermore, since toner particles and additives remaining on the surface of the latent image carrier can be effectively recovered in the cleaning device, compositions of toner particles and additives in the toner in the cleaning device can be readily controlled. As a result, in the cleaning device, the air gap can be effectively prevented from occurring between the toner and the latent image carrier, whereby the abrupt discharge can be prevented from occurring between the toner in the cleaning device and the surface of the latent image carrier.

Accordingly, even in the case of adopting the downward transfer method, the resistance of an elastic body formed on an outer periphery part of the rotation member is set to a value within a predetermined range, thereby to effectively inhibit occurrence of the leakage current between the cleaning device and the latent image carrier and the black spots in a formed image, which are caused by such leakage current.

In constituting the image forming apparatus of the invention, it is preferable that the toner includes the titanium oxide as an additive and assuming that a fluorescent X-ray intensity of the titanium oxide of the toner before use is X1 and a fluorescent X-ray intensity of the titanium oxide of the toner in the cleaning device is X2, the X1 and X2 satisfy a relational expression (1) below.

X2/X1≧1.5 (1)

This constitution makes it possible to effectively inhibit the air gap generated between the toner in the neighborhood of the cleaning blade in the cleaning device and the latent image carrier from occurring.

Accordingly, the toner in the neighborhood of the cleaning blade can be prevented from excessively charging and thereby the leakage current can be prevented from occurring, resulting in effectively inhibiting occurrence of the black spot due to the leakage current.

The relational expression (1) is sufficient when the relational expression (1) is satisfied at least at any one of a start time of the image forming apparatus and a predetermined time during an operation thereof.

More specifically, with a power supply switch of the image forming apparatus turned on, values of X1 and X2 can be directly measured, or, alternative characteristics of the fluorescent X-ray intensity are measured to indirectly confirm to satisfy.

It is sufficient that the relational expression (1) is confirmed to be satisfied when, at an arbitrary time during an operation of the image forming apparatus, the toners are sampled and values of X1 and X2 are directly measured or alternative characteristics of the fluorescent X-ray intensity are measured to indirectly measure values of X1 and X2. Here, an arbitrary time during an operation of the image forming apparatus is, for example, a time when 10 to 60 sec has elapsed after a power supply switch of the image forming apparatus is turned on or an arbitrary time up to printing 10 to 100,000 sheets of A4-size sheets.

However, as a reference measurement time of the fluorescent X-ray intensity, a time point when 1000 sheets of A4-size are printed is selected. At this time, it is preferable that the toner in the cleaning device is sampled, a value of X2 is directly measured by using a fluorescent X-ray analyzer and compared with a fluorescent X-ray intensity (X1) of the titanium oxide of the toner before use to confirm whether the relational expression (1) is satisfied or not.

Further, in constituting the image forming apparatus of the invention, a principal constituent material of the elastic layer in the rotation member is preferably at least one selected from the group consisting of ethylene-propylene-diene rubber, ethylene-propylene rubber, urethane rubber, silicone rubber, acrylic rubber and nitrile rubber.

This constitution makes it possible to readily control the resistance of the elastic layer in the rotation member in a predetermined range, and also to control the characteristics such as the hardness and the friction coefficient, thereby allowing the toner in the cleaning device to be sufficiently carried to the surface of the rotation member.

Furthermore, In constituting the image forming apparatus of the invention, the elastic layer in the rotation member is preferably formed of a resin foam and an average cell diameter in the resin foam is preferably set to a value within the range of 100 to 300 μm.

With this constitution, the toner in the cleaning device can be more efficiently carried to a surface of the rotation member.

In constituting the image forming apparatus of the invention, an Asker C hardness of the elastic layer in the rotation member is preferably set to a value in the range of 30 to 65 degree.

With this constitution, the toner in the cleaning device can be efficiently carried to the surface of the rotation member and simultaneously the surface of the latent image carrier can be effectively polished.

Moreover, in constituting the image forming apparatus of the invention, a rotation member is preferably grounded.

With this constitution, electric charges stored in the toner in the cleaning device can be effectively removed through the rotation member. Accordingly, the toner in the cleaning device can be prevented from excessively charging.

Furthermore, In constituting the image forming apparatus of the invention, a specific resistance of the titanium oxide is preferably set to a value in the range of 1×10⁰ to 1×10² Ω·cm.

This constitution makes it possible to more effectively prevent the toner in the cleaning device from excessively charging.

In the image forming apparatus of the invention, the cleaning device preferably has a toner receiving member for storing the toner scraped off the latent image carrier.

Due to such constitution notwithstanding a downward transfer method is adopted, the toner can be sufficiently carried by the rotation member in the cleaning device.

According to another aspect of the invention, there is provided an image forming method that includes the steps of: transferring a toner carried on a surface of a latent image carrier from downward to a transfer body; and cleaning a surface of the latent image carrier by using a cleaning device provided with a rotation member for cleaning the surface of the latent image carrier, wherein a resistance of an elastic layer formed on an outer periphery part of the rotation member is set to a value in the range of 1×10² to 1×10⁷Ω.

That is, according to such an image forming method, it is possible to inhibit excessive charging in the toner in the cleaning device and air gap therein from occurring, and it is accordingly possible to effectively suppress occurrence of a leakage current from the toner inside of the cleaning device to a surface of the latent image carrier and black spots caused thereby.

### BRIEF DESCRIPTION OF THE DRAWINGS

FIG. 1 is a diagram for explaining a fundamental structure of an image forming apparatus;

FIG. 2 is a diagram for explaining an image forming part including a developing device and a cleaning device;

FIGS. 3A and 3B are diagrams for explaining an embodiment of an electrophotographic photoconductor;

FIG. 4 is a diagram for explaining a fundamental structure of the cleaning device;

FIG. 5 is a graph for explaining a relationship between a resistance of an elastic layer and occurrence frequency of black spots;

FIGS. 6A to 6C are diagrams for explaining a state of an air gap and a situation when black spots are generated;

FIGS. 7A and 7B are diagrams for explaining a leakage current measurement system and its exemplary measurement chart;

FIG. 8 is a graph for explaining a relationship between a magnitude of an air gap and a potential difference between a toner layer and a photoconductor drum;

FIG. 9 is a graph for explaining a relationship between a content of an additive and a potential difference between a toner layer and a photoconductor drum;

FIG. 10 is a view for explaining a toner receiving member;

FIG. 11 is a graph for explaining a relationship between a specific resistance of the titanium oxide and occurrence frequency of black spots;

FIG. 12 is an exemplary chart of elemental analysis that uses a fluorescence X-ray analyzer (first one);

FIG. 13 is another exemplary chart of elemental analysis that uses a fluorescence X-ray analyzer (second one); and

FIG. 14 is a graph for explaining a relationship between a fluorescent X-ray intensity ratio (X1/X2) and occurrence frequency of black spots.

### DESCRIPTION OF THE PREFERRED EMBODIMENT

The invention is an image forming apparatus that comprises a latent image carrier that transfers a toner carried on a surface thereof from downward to a transfer body; and a cleaning device provided with a rotation member for cleaning the surface of the latent image carrier, wherein a resistance of an elastic layer formed on an outer periphery of the rotation member is set to a value in the range of 1×10² to 1×10⁷Ω.

Furthermore, another aspect of the invention is an image forming method that includes the steps of: transferring a toner carried on a surface of a latent image carrier to a transfer body from downward; and cleaning the surface of the latent image carrier by using a cleaning device provided with a rotation member that cleans the surface of the latent image carrier, wherein a resistance of an elastic layer formed on an outer periphery of the rotation member is set to a value in the range of 1×10² to 1×10⁷Ω.

Hereinbelow, the image forming apparatus and the image forming method of the invention will be specifically described appropriately with reference to the drawings.

### 1. Fundamental Constitution of Image Forming Apparatus

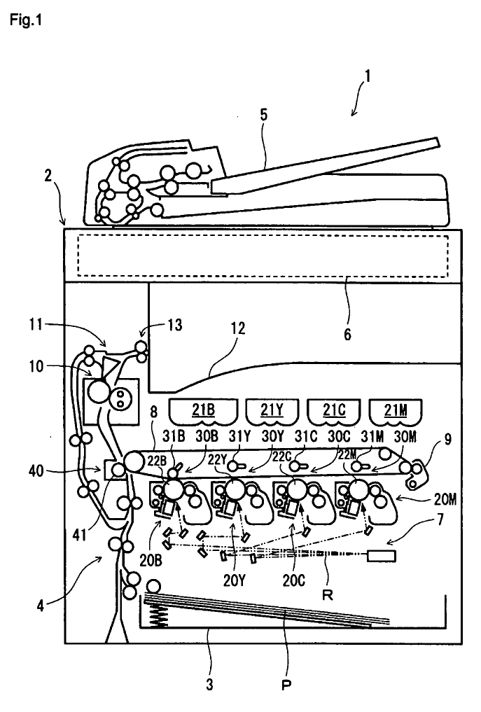

FIG. 1 is a front view in a vertical section of an image forming apparatus 1. The image forming apparatus 1 is a color printing image forming apparatus that adopts an intermediate transfer method and transfers a toner image on a paper. The image forming apparatus 1 also adopts a method where toners carried on surfaces of electrophotographic photoreceptors (hereinafter, in some cases, referred to as photoconductor drums) 22B, 22Y, 22C and 22M as latent image carriers are transferred to an intermediate transfer belt 8 as a transfer body from downward (hereinafter, in some cases, referred to as a downward transfer process).

Thus, adopting the downward transfer method allows to maintain high image quality and to arrange a black image forming part that is frequently used nearest to a secondary transfer position, whereby a first copy time can be shortened.

On the other hand, when the downward transfer method is adopted like this, in comparison with a case where a toner is transferred to a transfer body from an upper side, that is, an upward transfer method is adopted, a phenomenon is generated that the toner in the cleaning device tends to be excessively charged from a structural reason. Accordingly, in some cases, the black spots due to the leakage current from the toner in the cleaning device tend to be generated.

By contrast, in the image forming apparatus of the invention, the toner in the cleaning device can be effectively prevented from excessively charging and an air gap is effectively prevented from occurring between the toner and a latent image carrier.

Therefore, the image forming apparatus of the invention can effectively inhibit occurrence of the leakage current between the toner in the cleaning apparatus and the latent image carrier and the black spots in a formed image, which are due to the leakage current.

Now, respective constituent elements of the image forming apparatus of the present invention will be specifically described.

As shown in FIG. 1, inside and on lower side of a body 2 of the image forming apparatus 1, a paper cassette 3 is arranged. Inside of the paper cassette 3, papers P such as cut papers before print are stacked and stored. Then, the papers P are separated one by one and conveyed to a left upper side of the paper cassette 3. Further, the paper cassette 3 can be drawn level from a front side of the body 2.

A paper conveying part 4 is provided inside of the body 2 and on the left side of the paper cassette 3. The paper P delivered out of the paper cassette 3 is conveyed by the paper conveying part 4 vertically upward along the side surface of the body 2 to reach a secondary transfer part 40.

On the other hand, an original feeding part 5 is arranged on a top surface of the image forming apparatus 1, and an original image reader 6 is arranged below the original feeding part 5. When a user makes a copy of an original, an original where characters, figures and patterns are depicted is placed on the original feeding part 5.

Next, the original feeding part 5 separates originals one by one and sends out, and the original image reader 6 reads image data thereof. Then, information on the image data is transmitted to a laser illuminator 7 that is an exposure device arranged on the upper side of the paper cassette 3. Subsequently, the laser illuminator 7 illuminates laser light R controlled based on the image data to an image forming part 20.

Furthermore, image forming parts 20, four in total, are arranged on the upper side of the laser illuminator 7. Further on the upper side of the respective image forming parts 20, an intermediate transfer belt 8 is arranged where an intermediate transfer body is used in a form of an endless belt. The intermediate transfer belt 8 is wound around and supported by a plurality of rollers and rotated by a driving device (not shown) in a clockwise direction in FIG. 1.

Still furthermore, the four image forming parts 20 (20M, 20C, 20Y and 20B) are arranged in series from an upstream side in a rotational direction of the intermediate belt 8 to a downstream side thereof. The four image forming parts 20 are, in order from an upstream side, a magenta image forming part 20M, a cyan image forming part 20C, a yellow image forming part 20Y and a black image forming part 20B.

In order to replenish a toner, toner feeders 21M, 21C, 21Y and 21B corresponding to the image forming parts 20M, 20C, 20Y and 20B are arranged on the upper side of the intermediate transfer belt 8, and the toner is supplied to the respective image forming parts 20 by transport means (not shown).

In the description below, unless necessary to be particularly restricted, identification marks “M”, “C”, “Y” and “B” that show colors of the toners are omitted.

Subsequently, in the respective image forming parts 20, the laser light R is illuminated from the laser illuminator 7 that is an exposure device to generate an electrostatic latent image of an original image. Accordingly, a toner image is formed corresponding to the electrostatic latent image. Furthermore, on the upper side of the respective image forming parts 20, a primary transfer part 30 including a primary transfer roller 31 is arranged across the intermediate transfer belt 8.

The primary transfer roller 31 is movable in an up and down direction in FIG. 1 and, as needs arise, can be brought into pressure contact with or separated from the intermediate transfer belt 8. As the primary transfer roller 31 is brought into contact under pressure with the intermediate transfer belt 8, the intermediate transfer belt 8 is brought into contact under pressure with the image forming part 20 from the upper side to transfer a toner image formed by the image forming part 20 on the surface of the intermediate transfer belt 8. Subsequently, as the intermediate transfer belt 8 rotates, the toner images of the respective image forming parts 20 are transferred on the intermediate transfer belt 8 at a predetermined timing.

As a consequence, a color toner image where toner images of four colors of magenta, cyan, yellow and black are superposed is formed on the surface of the intermediate transfer belt 8.

At a place where the intermediate transfer belt 8 meets a paper transport path, the secondary transfer part 40 is arranged. The secondary transfer part 40 is provided with a secondary transfer roller 41. The color toner image on the surface of the intermediate transfer belt 8 is transferred on the paper P conveyed in synchronization by the paper conveying part 4 at a nip part that is formed by bringing the intermediate transfer belt 8 and the secondary transfer roller 41 into contact under pressure. Subsequently, the toner remaining on the surface of the intermediate transfer belt 8 after the secondary transfer is cleaned by a cleaning device 9 of the intermediate transfer belt 8, which is arranged on an upstream side in a direction of rotation of the magenta image forming part 20M relative to the intermediate transfer belt 8.

A fixing part 10 is arranged on the upper side of the secondary transfer part 40. At the secondary transfer part 40, the paper P carrying an undeveloped toner image is conveyed to the fixing part 10. Accordingly, The toner image is heated and pressurized and fixed by a fixing roller and a pressure roller.

A branched part 11 is arranged on the upper side of the fixing part 10. The paper P ejected from the fixing part 10, when it is not printed on both sides, is ejected from the branched part 11 into a housed paper ejection tray 12 of the image forming apparatus 1.

An ejection port from which papers P are ejected from the branched part 11 to the housed paper ejection tray 12 works as a switchback part 13. When both surfaces are printed, a transport direction of the paper P ejected from the fixing part 10 is switched at the switchback part 13. As a result, the paper P is conveyed through the branched part 11, a left side of the fixing part 10 and a left side of the secondary transfer part 40 to the lower side and conveyed once more through the paper conveying part 4 to the secondary transfer part 40.

### 2. Image Forming Part

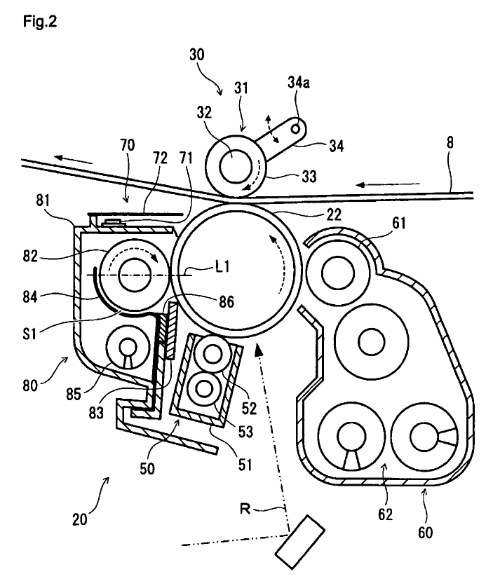

Next, the image forming part 20 will be further detailed with reference to FIG. 2. Since the respective image forming parts 20 (20M, 20C, 20Y and 20B) that use the toners of four colors of magenta, cyan, yellow and black) are common in structure, description will be given without restricting a toner color.

Here, as shown in FIG. 2, the image forming part 20 has, at a center thereof, a photoconductor drum 22 that is a latent image carrier. A charging device 50, a developing device 60, a charge neutralization device 70 and a cleaning device 80 are arranged in this order in the neighborhood of the photoconductor drum 22 along a rotational direction thereof. The primary transfer part 30 is arranged along a rotational direction of the photoconductor drum 22 between the developing device 60 and the charge neutralization device 70.

Hereinbelow, the image forming part 20 in the image forming apparatus 1 of the invention is divided into the latent image carrier (photoconductor drum), the charging device, the developing device, the charge neutralization device and the cleaning device, and each thereof will be specifically described.

### (1) Latent Image Carrier

Preferable examples of the photoconductor drum 22 as a latent image carrier include an organic photoconductor provided with a photosensitive layer made of a polycarbonate resin containing a charge generating agent and a charge transfer agent that are organic compounds, and an inorganic photoconductor provided with a photosensitive layer made of a-Si or a-Se that is an inorganic-type charge generating agent.

This is because when the latent image carrier is made of an organic photoconductor, the latent image carrier can be readily produced to be economical. However, since the organic photoconductor is poor in the endurance in comparison with the inorganic photoconductor, the inorganic photoconductor is preferably used in the image forming apparatus of the invention.

That is, when the latent image carrier is made of an inorganic photoconductor, a polishing effect in a cleaning step described below can be effectively exerted since a photosensitive layer has appropriate hardness. Accordingly, when the latent image carrier is an inorganic photoconductor provided with a photosensitive layer made of a-Si base material, a constant high quality image can be formed over a long term.

Therefore, an inorganic photoconductor will be taken as an example in the description below.

### (1)-1 Fundamental Constitution

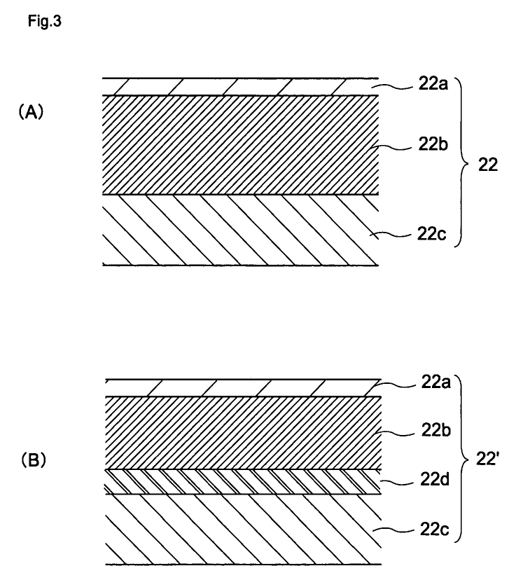

A fundamental constitution of the photoconductor drum 22 is preferable in which, as shown in FIG. 3A, at least a photoconductive layer 22b and a surface protective layer 22a are sequentially laminated on a base body 22c.

This is because, when such a surface protective layer 22a is arranged, while a surface polishing amount can be suppressed low, the image deletion can be prevented from occurring even under a high temperature and high humidity environment, and a function of the photoconductive layer 22b can be effectively exerted.

Further, as shown in FIG. 3B, the photoconductor drum 22 is preferably configured such that a charge injection inhibiting layer 22d made of a-Si base material is arranged on a base body 22c, and a photoconductive layer 22b and a surface protective layer 22a are sequentially laminated via the charge injection inhibiting layer 22d.

### (1)-2 Base Body

As the base body 22c in the photoconductor drum 22, preferably used are electroconductive members made of metals such as aluminum, stainless, zinc, copper, iron, titanium, nickel, chromium, tantalum, tin, gold and silver and alloys thereof. Also usable are base bodies obtained by forming, on a surface of an insulator such as resin, glass or ceramics, an electroconductive film made of the metal or a transparent conductive material such as ITO and SnO₂ by means of the vapor deposition.

Among these, an aluminum alloy is particularly preferred. This is because when an a-Si base material is used as a material of a photoconductive layer and a charge injection inhibiting layer, which will be described below, the adhesiveness with the layers can be improved and the weight saving and the cost saving can be obtained.

### (1)-3 Photoconductive Layer

As the photoconductive layer 22b in the photoconductor drum 22, preferably used are a-Si base material or a-Se base material such as Se—Te material or As₂Se₃ material.

In particular, a-Si base material or a material constituted by adding an element such as C, O or N to a-Si base material can form a photoconductor drum excellent in the photoconductivity, high-speed responsiveness, repetition stability, heat resistance and endurance and excellent in the balance among the various characteristics.

Specific examples of such a-Si base materials include a-Si, a-SiC, a-SiN, a-SiO, a-SiGe, a-SiCN, a-SiNO, a-SiCO and a-SiCNO.

With the a-Si base materials, a photoconductive layer can be formed by a plasma CVD method that employs, for example, a glow discharge decomposition method or an ECR method, a photo-induced CVD method, a catalyst CVD method and a reactive vapor deposition method.

Furthermore, when such a photoconductive layer is formed, hydrogen or a halogen element such as fluorine or chlorine is preferably added in the range of 1 to 40 atomic percent to a total amount for dangling bond termination.

The photoconductive layer 22b of the photoconductor drum 22 may preferably contain a IIIa group element in a periodic table (hereinafter, abbreviated as IIIa group element) or a Va group element in a periodic table (hereinafter, abbreviated as Va group element) or an element such as C, N and O.

This is because controlling contents of the elements allow appropriate adjustment of electric characteristics such as dark conductivity and photoconductivity and an optical band gap in the photoconductive layer.

A film thickness of the photoconductive layer is preferably appropriately controlled depending on a photoconductive material being used and desired electrophotography characteristics. When an a-Si material is used, the film thickness is preferably a value in the range of 5 to 100 μm and more preferably a value in the range of 10 to 80 μm.

### (1)-4 Surface Layer

As the surface layer 22a of the photoconductor drum 22, a-SiC and a-SiN etc. can be used.

This is because use of such a material allows light illuminated on the photoconductor drum to be transmitted to the photoconductive layer without being excessively absorbed.

This is also because the material has a specific resistance in the range of 1×10¹¹ to 1×10¹² Ω·cm to sufficiently maintain an electrostatic latent image in an image forming process.

Furthermore, that is because the material has a high hardness to provide sufficient resistance properties against the slide friction due to a rotation member.

Now, an example where a-SiC is used as a material will be specifically described.

In the beginning, a surface layer made of the a-SiC can be formed in such a manner that a Si-containing gas such as SiH₄ (silane gas) and a C-containing gas such as CH₄ (methane gas) are mixed and, similarly to the photoconductive layer, decomposed by a glow discharge decomposition method.

A composition ratio of Si and C in the surface layer can be controlled by varying a mixing ratio of the Si-containing gas and C-containing gas.

To the photoconductive layer, in the beginning, preferably laminated is a first a-SiC layer relatively high in a Si ratio, which has a value of x in the range of 0 to 0.8 when a-SiC is expressed as a-Siₗ₋ₓCₓ:H. Next, on the first layer, preferably laminated is a second a-SiC layer relatively high in a C ratio, which has a value of x in the range of 0.95 to 1.0 when a-SiC is expressed as a-Si₁₋ₓCₓ: H.

This is because, when the C ratio in a surface side of the surface layer is heightened, the image deletion under high temperature and high humidity environment can be prevented from occurring.

That is, when the C ratio on a surface side of the surface layer is heightened, it is possible to effectively prevent a layer surface from oxidizing due to ozone etc. generated owing to the corona discharge, which suppresses the hygroscopicity from becoming excessively high and also effectively prevents the image deletion from occurring under high temperature and high humidity environment.

A film thickness of the first a-SiC layer is preferably set to a value in the range of 0.1 to 2 μm.

This is because, when the film thickness of the first a-SiC layer is set to a value in such the range, influences on the pressure resistance, film strength and residual potential can be maintained in an excellent state.

Accordingly, the film thickness of the first a-SiC layer is more preferably set to a value in the range of 0.2 to 1 μm and further more preferably set to a value in the range of 0.3 to 0.8 μm.

Further, a film thickness of the second a-SiC layer is preferably set to a value in the range of 0.01 to 2 μm.

This is because, when the film thickness of the second a-SiC layer is set to a value in the range, influences on the pressure resistance, films trength, wear resistance and residual potential can be maintained in an excellent state.

Accordingly, the film thickness of the second a-SiC layer is more preferably set to a value in the range of 0.02 to 1 μm and further more preferably set to a value in the range of 0.05 to 0.8 μm.

Similarly to the formation of the photoconductive layer, a plasma CVD method etc. is preferably used as a method of forming a surface layer made of a-SiC.

### (1)-5 Charge Injection Inhibiting Layer

The charge injection inhibiting layer 22d in the photoconductor drum 22 is a layer arranged for inhibiting carriers (electrons) from being injected from the base body 22c. As a constituent material of the charge injection inhibiting layer, usable is a composite material obtained by adding boron, nitrogen and oxygen as the dopant to a-Si.

A film thickness of the charge injection inhibiting layer is preferably set to a value in the range of 2 to 7 μm and more preferably in the range of 3 to 6 μm.

Similarly to the formation of the photoconductive layer and surface layer, a plasma CVD method etc. can be preferably adopted as a method of forming the charge injection inhibiting layer.

### (2) Charging Device

As a kind of a charging device, non-contact charging means such as scorotron is preferably used, and as shown in FIG. 2, a charging roller 52 is more preferably used.

This is because use of the charging roller 52 enables to effectively suppress discharge products such as ozone that is readily generated in the non-contact charging process.

The charging roller 52 is preferably constituted to include a core metal, a conductive layer arranged outside thereof and a resistance layer arranged further outside thereof. In order to further clean the surface of the charging roller 52, a cleaning brush 53 that comes into rotation contact with a surface of the charging roller 52 a housing 51 is preferably further provided.

In order to maintain a contact force against the surface of the charging roller 52 always constant, though not shown in the drawing, a pressure control member can be preferably arranged between the cleaning brush 53 and the housing 51.

### (3) Developing Device

As shown in FIG. 2, in the developing device 60, a photo sensitive non-contact developing roller 61 is preferably arranged in the neighborhood of the photoconductor drum 22.

In such a constitution, when a bias having the polarity same as the discharging polarity of the photoconductor drum 22 is applied to the developing roller 61, a toner that is a developing agent is charged and flies to an electrostatic latent image on the surface of the photoconductor drum 22 to develop an electrostatic latent image.

The developing roller 61 may be a contact type with the photoconductor drum.

The primary transfer part 30 is provided with the primary transfer roller 31 that comes into contact with the photoconductor drum 22 through the intermediate transfer belt 8. The primary transfer roller 31 includes a core metal 32 and a conductive elastic layer 33 arranged outside thereof.

The conductive elastic layer 33 is made of polyurethane rubber having an electroconductive material such as carbon dispersed therein. Furthermore, the primary transfer roller 31 is supported through an arm 34 by a frame (not shown). The arm 34 is rotatable with an axis part 34a thereof as a center, and owing to the rotation operation, the primary transfer roller 31 moves up and down.

Accordingly, without having a driving device, the primary transfer roller 31, owing to contact with the intermediate transfer belt 8, can rotate as the intermediate transfer belt 8 rotates.

Furthermore, the primary transfer roller 31, in synchronization with the toner image formation on the surface of the photoconductor drum 22, moves downward to come into contact with the intermediate transfer belt 8. According to this, the intermediate transfer belt 8 is pushed down to come into contact with the photoconductor drum 22. At that time, a transfer bias having negative polarity that is an opposite polarity to the photoconductor drum 22 and the toner is applied to the primary transfer roller 31. Thereby, the toner tries to move from the photoconductor drum 22 toward the primary transfer roller 31 and a toner image is contact transferred on the intermediate transfer belt 8. When the primary transfer roller 31 moves upward, the intermediate transfer belt 8 is separated from the photoconductor drum 22.

### (4) Charge Neutralization (Elimination) Device

As shown in FIG. 2, the charge neutralization device 70 is arranged along a rotational direction of the photoconductor drum 22 on a further downstream side of the primary transfer part 30.

The charge neutralization device 70 is preferably constituted of a LED (light-emitting diode) 71 and a reflective plate 72. The LED 71 is arranged on a top surface of a housing 81 of the cleaning device 80.

In place of the LED 71, an EL (electroluminescence) light source or a fluorescent lamp can be preferably used. In that case, the reflective plate 72 is preferably arranged on the upper side of the LED 71 so as to cover the LED 71.

### (5) Cleaning Device

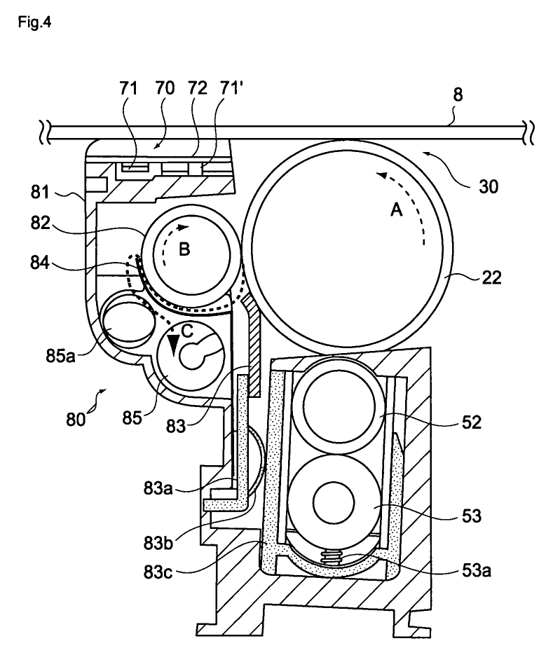

Next, the cleaning device 80 will be more detailed with reference to FIG. 4.

The cleaning device 80 is arranged on a further downstream side of the primary transfer part 30 and charge neutralization device 70 along a rotational direction of the photoconductor drum 22 and constituted fundamentally of a cleaning blade 83, a rotation member 82, a toner receiving member 84 and the housing 81.

The cleaning device 80 further includes a sweep roll 85a and a recovery roller 85.

### (5)-1 Cleaning Blade

The cleaning device 80 has the cleaning blade 83. This is because the cleaning blade can effectively scrape the residual toner off the surface of the photoconductor drum.

It is preferable that, as shown in FIG. 4, the cleaning blade 83 is arranged on a downstream side in a rotational direction of the photoconductor drum 22 of the rotation member 82 described below and on the lower side in an up and down direction relative to the rotation member 82 in the housing 81. The cleaning blade 83 is pressed, by energizing means 83a and 83b, against the photoconductor drum 22 under a predetermined force.

Furthermore, the cleaning blade 83 is a planar member made of urethane rubber, silicone rubber, SBR, natural rubber, acrylic rubber or other resin materials, and has an axis line direction length substantially same as that of the photoconductor drum 22.

When a constituent material of the cleaning blade further contains a predetermined amount of carbon black or the titanium oxide, the endurance thereof can be improved or the electric conductivity thereof can be imparted.

### (5)-2 Rotation Member

As shown in FIG. 4, the cleaning device 80 includes the rotation member 82 for cleaning the surface of the photoconductor drum 22.

The reason for this is that, when the cleaning device is provided with the rotation member 82, the surface of the photoconductor drum 22 can be effectively polished with, for example, the titanium oxide as an additive in the toner. Accordingly, foreign matters attached on the surface of the photoconductor drum 22 can be effectively removed, whereby surface characteristics of the photoconductor drum 22 such as the friction coefficient and surface roughness can be maintained in an excellent state.

Furthermore, a resistance of an elastic layer formed on an outer periphery part of the rotation member 82 is set to a value in the range of 1×10² to 1×10⁷Ω.

The rotation member 82 is preferably grounded.

This is because, even in an image forming apparatus adopting a downward transfer method like the image forming apparatus of the invention, the resistance of the elastic layer formed on an outer periphery part of the rotation member is set to a value in a predetermined range and such a rotation member is grounded, with the result that the leakage current between the cleaning device and the latent image carrier and black spots in a formed image, which are caused by the leakage current, can be effectively prevented from occurring.

That is, when the resistance of the elastic layer formed on the outer periphery of the rotation member is set in a predetermined range, the toner in the cleaning device can be effectively prevented from excessively charging.

In more specifically, in an image forming apparatus where the downward transfer method is adopted, the rotation member can carry the toner with difficulty, owing to structural problems thereof. This is because the residual toner scraped off the photoconductor drum surface by the cleaning blade tends to move (fall) as it is under an action of gravity.

In this connection, in the cleaning device in the image forming apparatus that adopts the downward transfer method, generally, a residual toner is stored in the neighborhood of the rotation member in the cleaning device in order that the residual toner may be effectively carried on the rotation member (for example, a toner receiving member described below can be specifically cited).

However, in the cleaning device thus configured, the toner stored in the cleaning device, and the rotation roller and the photoconductor drum are always in contact under friction, and thus, there is a problem in that the toner is excessively charged. Then, the electric charges accumulated in the toner abruptly discharge to generate a leakage current to flow to the photoconductor drum surface. As a result, the photoconductor drum surface is damaged, and black spots are generated on a formed image.

On the other hand, according to the image forming apparatus of the invention, the resistance of the elastic layer formed on the outer periphery part of the rotation member is stipulated in a predetermined range. Accordingly, electric charges accumulated in the toner in the cleaning device can be effectively removed through the rotation member. As a result, the toner in the cleaning device can be prevented from excessively charging.

Furthermore, when the resistance of the elastic layer formed on the outer periphery of the rotation member is set to a value in the predetermined range, toner particles and additives remaining on the photoconductor drum surface can be efficiently recovered in the cleaning device. As a result, compositions of the toner particles and additives of the toner in the cleaning device can be readily controlled. Accordingly, in the cleaning device, an air gap can be effectively prevented from occurring between the toner and the latent image carrier, thereby to inhibit occurrence of the abrupt discharge between the toner in the cleaning device and a surface of the latent image carrier.

That is, the cleaning device in the image forming apparatus that adopts the downward transfer method, as mentioned above, is generally configured so that the toner is stored in the cleaning device to be effectively carried to the rotation member.

However, in the cleaning device having such a constitution, in some cases, an air gap is generated between the toner stored in the cleaning device and the photoconductor drum. By the air gap, the toner tends to store charges and the abrupt discharge tends to occur. The abrupt discharge may damage the photoconductor drum surface, thereby generating black spots in a formed image.

On the other hand, according to the image forming apparatus of the invention, the toner remaining on the photoconductor drum surface, in particular, the additives such as the titanium oxide, can be efficiently recovered in the cleaning device since the resistance of the elastic layer formed on the outer periphery part of the rotation member is stipulated in a predetermined range. More specifically, the rotation member of the invention enables to weaken an electrostatic force between the residual toner and the photoconductor drum by neutralizing electric charges of the charged residual toner. Consequently, the toner remaining on the photoconductor drum surface can be efficiently recovered in the cleaning device. Accordingly, since the air gap can be filled by the additives such as titanium oxide, the toner in the cleaning device can be prevented from excessively storing electric charges and the abrupt discharge can be effectively prevented from occurring.

Thus, when the resistance of the elastic layer formed on the outer periphery part of the rotation member is set to a value in a predetermined range, it is possible to effectively suppress occurrence of the leakage current between the cleaning device and the latent image carrier and black spots in a formed image, which are caused by the leakage current.

When the resistance of the elastic layer formed on the outer periphery part of the rotation member is below 1×10²Ω, electric charges tend to move between the latent image carrier and the cleaning device through the rotation member, so that in some cases, the charging characteristics in the latent image carrier are adversely affected. On the other hand, when the resistance of the elastic layer formed on the outer periphery part of the rotation member is above 1×10⁷Ω, it is may be difficult to effectively suppress the leakage current between the cleaning device and the latent image carrier and black spots in a formed image, which are caused by the leakage current.

Accordingly, the resistance of the elastic layer formed on the outer periphery part of the rotation member is preferably set to a value in the range of 5×10² to 5×10⁶Ω and more preferably a value in the range of 1×10³ to 1×10⁶Ω.

Furthermore, a method of measuring the resistance of the elastic layer will be detailed in Examples described below.

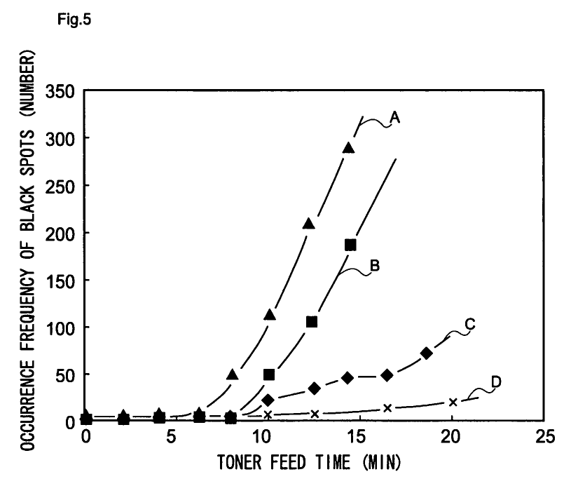

Next, the relationship between the resistance of the elastic layer formed on the outer periphery part of the rotation member and the occurrence frequency of the black spots will be specifically described with reference to FIG. 5.

FIG. 5 shows the characteristic curves A to D in which the abscissa indicates a toner feed time (min) and the ordinate indicates the occurrence frequency of black spots (number) when an accelerated experiment is carried out.

As the conditions of the accelerated experiment, a toner obtained by adding the titanium oxide as an additive thereto so as to be 1.5% by weight to a total amount of the toner was used, a photoconductor provided with an a-Si photosensitive layer having a film thickness of 15 μm was used, and a primary transfer bias was turned off. Accordingly, a cleaning device was constituted so that a developed toner was all recovered therein, and, in this state, a printing operation is carried out to carry out an accelerated test without passing an A4-size paper and with a ratio of white to black kept at 6% (corresponding to A4-size original) at a printing speed of 23 sheets/min.

Furthermore, results of the accelerated test are separately confirmed to be correlated with the occurrence frequency of black spots under actual image forming conditions.

Here, the characteristic curves A to D, respectively, correspond to cases where rotation members provided with elastic layers respectively having the characteristics below are used to form an image.

### Characteristic curve A: Use is a rotation member mainly made of EPDM and provided with an elastic layer of which resistance is 1.5×10⁸Ω.

### Characteristic curve B: Used is a rotation member mainly made of EPDM and provided with an elastic layer of which resistance is 1.3×10⁶Ω.

### Characteristic curve C: Use is a rotation member mainly made of EPDM and provided with an elastic layer of which resistance is 1.4×10⁴Ω.

### Characteristic curve D: Used is a rotation member mainly made of EPDM and provided with an elastic layer of which resistance is 1.3×10³Ω.

As can be understood from the characteristic curves A to D, as a value of the resistance (Ω) of the elastic layer formed on the outer periphery part of the rotation member becomes larger, the black spots are more likely to occur.

More specifically, in the characteristic curve A where the resistance (Ω) of the elastic layer is above 1×10⁷Ω, the black spots start occurring from around the toner feed time (min) that is above 5 min. On the other hand, it is found that, in the characteristic curves B to D where the resistance (Ω) of the elastic layer is below 1×10⁷Ω, the black spots can be suppressed from occurring up to around the toner feed time (min) that is above 8 min.

Furthermore, when attention is paid to a gradient of a characteristic curve, it is found that the larger the resistance (Ω) of the elastic layer is, the larger the gradient is. In the relationship with actual image forming conditions, a difference of the gradient of the characteristic curves is largely correlated with occurrence of the black spots, more than a difference between times where the black spot starts occurring in the accelerated test. Accordingly, a difference of the gradients of the characteristic curves A and B appears as a very large difference in the occurrence of the black spots under actual image forming conditions.

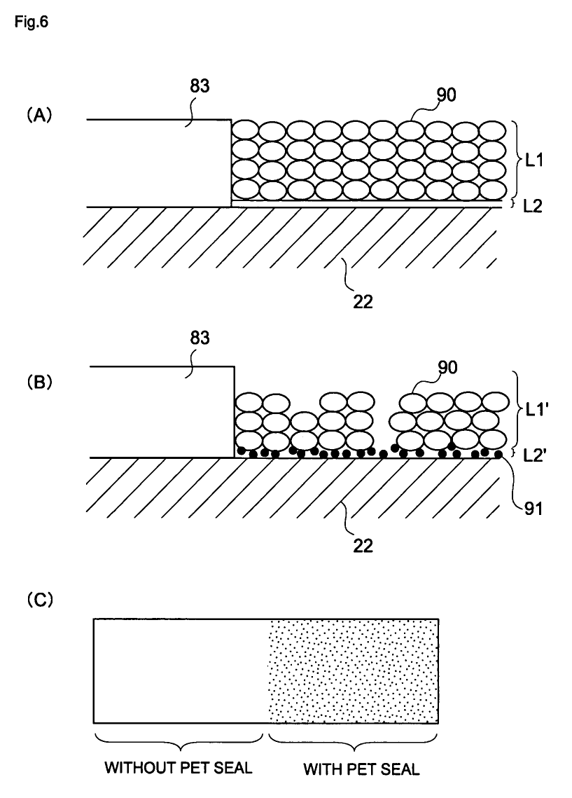

Subsequently, with reference to FIGS. 6A to 6C, description will be given to mechanisms of: occurrence of a leakage current from the toner inside of the cleaning device to the photoconductor drum; occurrence of the black spots due to the leakage current; and suppression thereof.

In the beginning, as shown in FIG. 6A, in a cleaning device when an image forming operation is repeated, a toner is packed and the toner flows as the photoconductor drum or the rotation member rotates, so that the friction is always generated between the toners each other and between the toner and the rotation member or the cleaning blade. As a result, when an image forming operation is repeated, the toner in the cleaning device is naturally charged.

On the other hand, the toner scraped off the surface of the electrophotographic photoconductor by the cleaning blade is assumed to form an air gap (L2) of substantially in the range of 0.1 to 10 μm between the toner and the photoconductor drum. The air gap (L2) swells up when new residual toners are successively transported between the toner layer (L1) formed on the photoconductor drum and the photoconductor drum to collide with the cleaning blade, whereby the toner layer (L1) is pushed upward in FIG. 6A.

Then, electric charges stored in the toner layer (L1) are insulated by the air gap (L2) to lose a chance of gradually discharging to the photoconductor drum. Consequently, the toner layer (L1) tends to be an excessively charged state.

As a result, when a charging amount in the toner layer (L1) exceeds a definite level, the discharge is generated at the air gap (L2).

Accordingly, the leakage current is caused from the toner in the cleaning device to the photoconductor drum in this manner.

Since the photoconductor drum is damaged owing to the leakage current, the damaged part is observed as a black spot in a formed image.

With reference to FIG. 6C, description will be given to the relationship between excessive charging in the toner in the cleaning device and occurrence of the black spots in a formed image.

That is, experimentally, a PET seal (PET: 50 μm, tacky layer: 50 μm) was adhered on a front half in a depth direction of the toner receiving member 84 arranged in the cleaning device 80 shown in FIG. 4. Consequently, of a gap formed between the toner receiving member 84 and the rotation member 82 arranged in the upper side thereof, the front half in the depth direction of the toner receiving member is completely clogged with the PET seal.

On the other hand, the gap of the rear half in the depth direction of the toner receiving member 84 is left as it is.

Next, a predetermined image is printed on 1000 sheets of A4-size paper with the image forming apparatus provided with the cleaning device in such a state.

At this time, since the toner cannot be ejected on a side where the PET seal is adhered in the cleaning device, the toner is packed in high density. In addition, since the rotation member 82 and the photoconductor drum 22 rotate, the toner of such a part is excessively charged owing to the friction.

On the other hand, the toner is ejected along a rotation direction of the rotation member 82 on a side where the PET seal is not adhered in the cleaning device 80, and thus, the toner is not excessively charged in comparison with the side where the PET seal is adhered.

In FIG. 6C, a white-paper image formed after the image formation is partially shown. As understood from the FIG. 6C, the black spots are remarkably observed in an image formed on a part of the photoconductor drum located on the side where the PET seal is adhered (front half in a depth direction).

On the other hand, in an image formed on a part of the photoconductor drum located on the side where the PET seal is not adhered (rear half in a depth direction), the black spot is not at all observed.

From the results, it is understood that a close relationship exists between the excessive charging of the toner in the cleaning device and the occurrence of the black spots in a formed image.

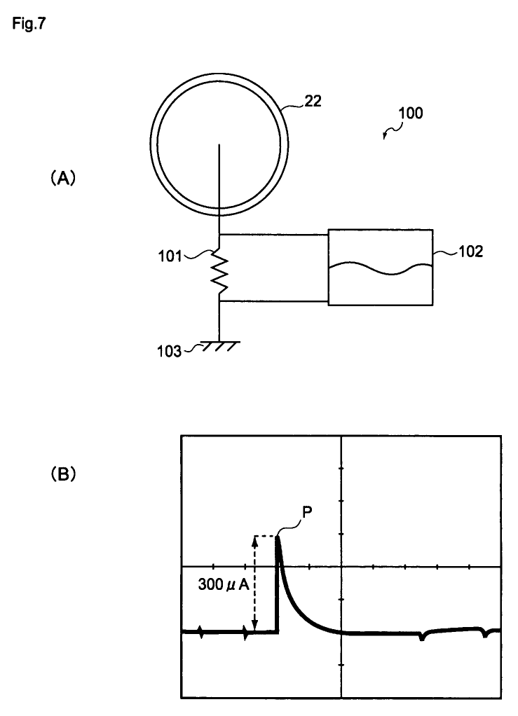

Next, with reference to FIGS. 7A and 7B, description will be given to the relationship between the excessive charging of the toner in the cleaning device and the leakage current between the cleaning device and the photoconductor drum. That is, FIG. 7A is a diagram showing a detection system 100 for detecting the leakage current between the cleaning device and the photoconductor drum, and FIG. 7B is measurement chart of the current.

When a leakage current is measured, the toner receiving member 84 of the cleaning device 80 shown in FIG. 4 was filled with a toner in advance and a new a-Si photoconductor drum 22 was mounted on the image forming apparatus 1.

Next, with a resistance (12 kΩ) 101 connected to a drum earth, voltage variations (current variations) at both ends of the resistance 101 were measured with an oscilloscope 102.

As other measurement conditions, a drum shaft and a motor are electrically insulated with a PET film, and the rotation member and the toner receiving member are grounded. Furthermore, a charging step, a transfer step and a developing step are not carried out and omitted.

The result shows that, as shown in FIG. 7B, a leakage current that has a waveform having a peak (P) and a value of the peak (P) of substantially 300 μA instantaneously flows. Furthermore, it has been separately confirmed that, when the leakage current like this flows, the surface of the a-Si photoconductor is damaged and a black spot is generated corresponding to that part.

From the results, it has been found that electric charges excessively stored in the toner in the cleaning device causes the leakage current between the cleaning device and the photoconductor drum and the leakage current damages the surface of the photoconductor drum, leading to occurrence of the black spots.

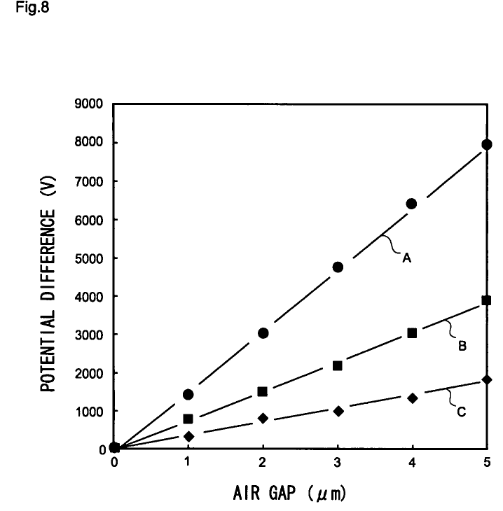

Next, with reference to FIG. 8, specific description will be given to the relationship among a magnitude of the air gap, a potential difference between the toner layer and the photoconductor drum and a toner layer thickness.

FIG. 8 shows characteristic curves A to C in which the abscissa indicates a magnitude (μm) of the air gap and the ordinate indicates a potential difference (V) between the toner layer and the photoconductor drum. The characteristic curves A to C correspond to cases where a toner charge amount in the toner layer is set to 4 μC/g and thicknesses of the respective toner layers are set to 1 mm, 2.3 mm and 5 mm.

As obvious from the characteristic curves A to C as well, the potential difference (V) between the toner layer and the photoconductor drum, the magnitude (μm) of the air gap, and the toner layer thickness (mm) are substantially proportional.

It is also found that the potential difference between the toner layer and the photoconductor drum when, for example, in the characteristic curve B, a magnitude of the air gap is 3 μm, is a value of 2000 V or above. This shows that the potential difference between the toner layer and the photoconductor drum under the conditions where the magnitude of the air gap is 3 μm and the toner layer thickness is 2.3 mm becomes a value of 2000 V or above.

The magnitude of the air gap and thickness of the toner layer are assumed to be average conditions. Accordingly, it shows that, even under actual image forming conditions, the potential difference between the toner layer and the photoconductor drum can be a value of 2000 V or above. It is understood that, under the conditions, the discharge is caused and very large current leaks to the photoconductor drum, with the result that the surface of the photoconductor drum is damaged.

On the other hand, when a rotation member having an elastic layer with a predetermined resistance is used, the neighborhood of the cleaning blade is confirmed to be a state shown in FIG. 6B from a micrograph.

That is, it is found that not only a thickness of the toner layer (L1′) is relatively thin, but also a gap is formed in the deposited layers. Above all, it is found that an additive such as titanium oxide is present between the toner layer (L1′) and the photoconductor drum to effectively suppress an air gap from being generated. Such an effect is caused because the toner remaining on the surface of the photoconductor drum, in particular, the additive such as titanium oxide can be effectively recovered in the cleaning device.

Accordingly, when the specific resistance in the additive such as titanium oxide is controlled in an appropriate range, electric charges accumulated in the toner layer (L1′) can be gradually released to the photoconductor drum, with the result that the photoconductor drum can be effectively prevented from being damaged by the leakage current.

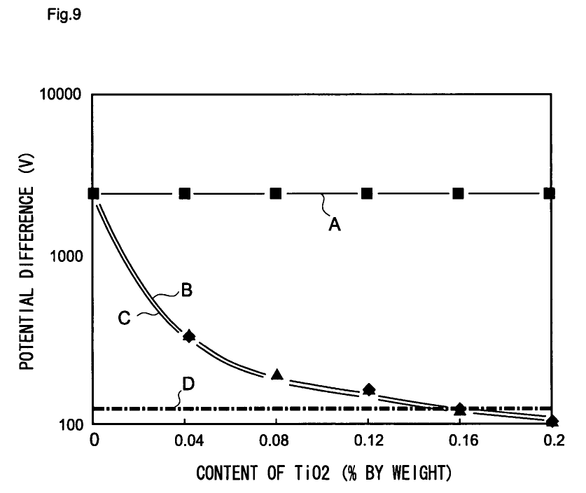

Then, with reference to FIG. 9, description will be given to the relationship between the titanium oxide as an additive and the potential difference between the toner layer and the photoconductor drum.

In FIG. 9, the abscissa indicates a content (% by weight) of the titanium oxide and the ordinate indicates the potential difference (V) between the toner layer and the photoconductor drum. Characteristic curves A to C corresponding thereto are shown.

The characteristic curves A to C are characteristic curves where, a toner charging amount in the toner layer is set to 4 μC/g, a toner layer thickness is set to 2.3 mm, a magnitude of the air gap is set to 3 μm and the titanium oxide contents are virtually set respectively as follows.

### Characteristic curve A: A content (% by weight) when the titanium oxide is contained only in the toner layer.

### Characteristic curve B: A content (% by weight) when the titanium oxide is contained only in the air gap.

### Characteristic curve C: A content (% by weight) when the titanium oxide is contained in both of the toner layer and air gap.

A characteristic curve D shows a potential difference where the spark discharge is caused between the toner layer and the photoconductor drum and, in a region above the characteristic curve D, the spark discharge is caused and thereby the black spots may be generated.

As obvious from the characteristic curve A, when only the content (% by weight) of the titanium oxide of the toner layer is increased, the potential difference (V) between the toner layer and the photoconductor drum keeps on maintaining substantially 2000 V and hardly varies.

As obvious from the characteristic curve B, on the other hand, only the content (% by weight) of titanium oxide in the air gap is increased, the potential difference (V) between the toner layer and the photoconductor drum decreases in association with the increase. More specifically, it is found that, when the content (% by weight) of titanium oxide in the air gap is increased to 0.04% by weight, the potential difference (V) rapidly decreases from substantially 2000 V to substantially 550V. It is also found that, when the content (% by weight) of titanium oxide in the air gap is further increased, the potential difference (V) keeps on decreasing while weakening the extent of decrease.

As obvious from characteristic curves C and B that are depicted substantially overlapped, it is found that, when the content (% by weight) of titanium oxide in both of the toner layer and the air gap is varied, only the content (% by weight) of titanium oxide in the air gap affects on the potential difference (V).

Accordingly, it is clear from the characteristic curves A to C shown in FIG. 9 that, when the content (% by weight) of titanium oxide in the air gap is increased, the potential difference (V) between the toner layer and the photoconductor drum can be decreased.

Furthermore, a primary constituent material of the elastic layer in the rotation member 82 is preferably at least one kind selected from the group consisting of ethylene-propylene-diene rubber, ethylene-propylene rubber, urethane rubber, silicone rubber, acrylic rubber and nitrile rubber.

This is because, when a primary constituent material in the elastic layer is one of the rubber materials, it is possible not only to readily control the resistance of the elastic layer in the rotation member within a predetermined range, but also to control the characteristics such as the hardness and the friction coefficient thereof to allow the toner in the cleaning device to be effectively carried on the surface of the rotation member.

Examples of a method of controlling the resistance of the elastic layer in the rotation member include a method of adding, for example, carbon black, metal particles, alkali metal salt or perchlorate as a conductivity imparting agent to the primary constituent material.

It is preferred that the elastic layer in the rotation member is made of a resin foam and an average cell diameter of the resin foam is set to a value in the range of 100 to 300 μm.

This is because, when the elastic layer of the rotation member is formed of a resin foam having a predetermined average cell diameter, the toner in the cleaning device can be carried more effectively on the surface of the rotation member.

More specifically, that is because when an average cell diameter is below 100 μm, foam cells tend to be clogged, and in some cases, the toner in the cleaning device can be efficiently carried with difficulty, while on the other hand, when an average cell diameter is above 300 μm, the foam cells affect largely, and it is difficult in some cases to control the resistance and the hardness of the elastic layer per se within an appropriate range.

Accordingly, the average cell diameter in the resin foam as the elastic layer of the rotation member is set preferably in the range of 120 to 280 μm and more preferably in the range of 140 to 260 μm.

The Asker C hardness of the elastic layer in the rotation member is preferably set to a value in the range of 30 to 65 degrees.

This is because, when the Asker C hardness of the elastic layer of the rotation member is set to a value in the range, the toner in the cleaning device can be efficiently carried on the surface of the rotation member and a surface of a latent image carrier can be effectively polished.

That is, this is because when the Asker C hardness is below 30 degrees, it is in some cases impossible to sufficiently exert a polishing effect owing to a polishing agent such as titanium oxide carried by the rotation member, while on the other hand, when the Asker C hardness is above 65 degrees, a nip width in a contact portion between the rotation member and the photoconductor drum cannot be sufficiently secured in some cases.

Accordingly, the Asker C hardness of the elastic layer of the rotation member is preferably set to a value in the range of 40 to 60 degrees and more preferably to a value in the range of 45 to 55 degrees.

As a magnitude of the rotation member, a diameter thereof is preferably set to a value in the range of 10 to 30 mm. In order to make an effective polishing area of the rotation member 82 larger, it is preferred to have a length in an axis direction substantially same as that of the photoconductor drum 22.

As shown in FIG. 4, the rotation member 82 is preferably arranged, on an upper side in the housing 81, so as to be pressed against the photoconductor drum 22 under a predetermined force by using energizing means (not shown) provided at both ends of a shaft part.

Further, the rotation member 82 is preferably rotated by driving means constituted of a motor or the like. In order to efficiently polish the surface of the photoconductor drum 22, the rotation member 82 is preferably rotated at a predetermined circumferential speed.

That is, it is preferred that the rotation member 82, as shown with an arrow mark B in FIG. 4, is rotated in a direction in which a surface of the rotation member 82 coming into contact with the photoconductor drum 22 moves in a direction same as that of the surface of the photoconductor drum 22 (arrow mark A in FIG. 4). The circumferential speed of the rotation member 82 is preferably set to a value in the range of 1 to 2 times a circumferential speed of the photoconductor drum 22.

### (5)-3 Toner Receiving Member

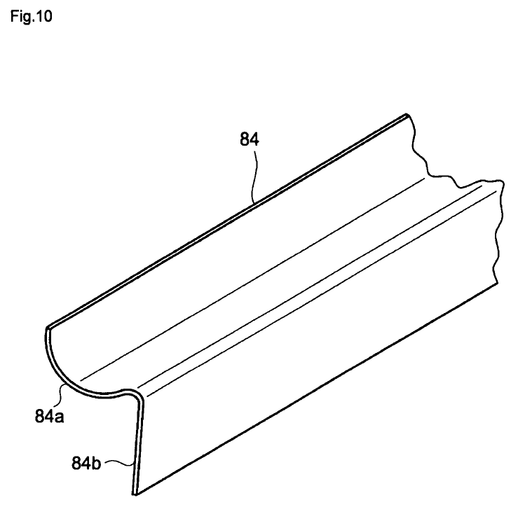

As shown in FIG. 4, the cleaning device 80 preferably has the toner receiving member 84 for storing the toner scraped off the photoconductor drum 22. As shown in FIG. 10, the toner receiving member 84 is preferably a gutter-like member along a circumferential surface of the rotation member 82.

This is because providing the toner receiving member 84 allows titanium oxide or the like as an additive to be sufficiently carried on the rotation member 82 even in the image forming apparatus of the invention that adopts the downward transfer method as shown in FIG. 4.

This is also because, when the toner receiving member 84 is used, the toner can be smoothly conveyed through a sweep roll 85a to the toner recovery part 85 as shown with an arrow mark C in FIG. 4.

That is, the toner eliminated from the surface of the photoconductor drum 22 by the rotation member 82 and the cleaning blade 83, when the toner receiving member 84 is not arranged, tends to move (fall) as it is below the rotation member 82 and the cleaning blade 83 under the action of gravity.

However, since the toner movement is interrupted by the toner receiving member 84, the toner is stored in a gap in the neighborhood of the circumferential surface of the rotation member 82 constituted by the toner receiving member 84. The toner, when stored in the gap, presses against the rotation member 82. As a result, the toner can be carried in the gap by the rotation member 82 from downward.

The toner that have not adhered to the rotation member 82 under the action of pressure as well can be carried at an end part on a downstream side of the toner receiving member 84 in a rotational direction of the rotation member 82 by the rotation member 82 under the action of the gravity.

Then, the rotation member 82 can polish the surface of the photoconductor drum 22 by using the toner adhered on the surface of the rotation member 82 and containing the additive.

As mentioned above, while the additive can be effectively carried by the rotation member 82, the toner can be stably conveyed in a rotational direction thereof by making use of the rotation of the rotation member 82.

As shown in FIG. 2, an end part on a downstream side relative to a rotation direction of the rotation member 82 in the toner receiving member 84 is preferably located on the upper side than a contact part between the rotation member 82 and the photoconductor drum 22.

This is because this constitution enables to maintain a state where the toner receiving member 84 is appropriately filled with the toner.

Accordingly, the toner can be more efficiently carried by the rotation member 82 and the toner can be more smoothly conveyed to the toner recovery part 85.

Examples of the material of the toner receiving member 84 include stainless (SUS), aluminum (Al), copper (Cu), silver (Ag), a ceramic material, a conductive polycarbonate resin, an insulating polycarbonate resin, a conductive acrylic resin and an insulating acrylic resin.

The toner receiving member 84 preferably has a length substantially same as that in a shaft line direction of the rotation member 82. The toner receiving member 84 is preferably constituted in such a manner that, with a part at the end portion thereof on the downstream side in the rotational of the rotation member 82 left, the housing 81 is partitioned into a space where the rotation member 82 and the cleaning blade 83 are arranged and a space where the recovery roller 85 is arranged and the toner eliminated from the photoconductor drum 22 is stored in a gap in the neighborhood of the circumferential surface of the rotation member 82.

Further, in order to fill the gap, a sponge (not shown) is preferably packed between the toner receiving member 84 and the cleaning blade 83. At both end parts in a sheet width direction of the toner receiving member 84, a seal member such as an unillustrated sponge is arranged between the toner receiving member 84 and the housing 81 so as to inhibit the toner stored in the toner receiving member 84 from leaking therefrom.

### (5)-4 Sweep Roller

The sweep roller 85a shown in FIG. 4 is a conveying member that, as shown with an arrow mark C, smoothly conveys the toner eliminated from the surface of the photoconductor drum 22 by the rotation member 82 and the cleaning blade 83 to the toner recovery part 85.

That is, the sweep roller 85a is a spherical rotation member that inhibits the toner from remaining in the housing 81 and agitates the toner so as to be uniform.

The sweep roller 85a may be made of a resin, metal or ceramics. However, it can be configured similarly to known one.

### (5)-5 Recovery Roller

As shown in FIG. 4, the recovery roller 85 is preferably arranged on the lower side of the rotation member 82 in the housing 81.

This is because, by using the recovery roller 85, a waste toner in the housing 81, which has been used for cleaning, can be efficiently ejected outside of the housing 81, that is, in a waste toner recovery vessel.

The recovery roller 85 extends from the inside of the housing 81 to the waste toner recovery vessel (not shown) arranged outside of the image forming part 20.

### 3. Toner

Available examples of the toner to be used include a magnetic or nonmagnetic one-component toner or a two-component toner in which a magnetic carrier and a nonmagnetic toner are mixed.

An average particle diameter of the magnetic toner is not particularly restricted, but it is preferably set to a value in the range of, for example, 5 to 12 μm.

This is because when an average particle diameter of the magnetic toner is below 5 μm, the charging characteristics and the fluidity of the magnetic toner are deteriorated and, furthermore the isolation rate of the additive may become higher, while on the other hand, when the average particle diameter of the magnetic toner is above 12 μm, the fluidity of the toner may be deteriorated.

Accordingly, the average particle diameter of the magnetic toner is preferably set to a value in the range of 6 to 11 μm and more preferably set to a value in the range of 7 to 10 μm.

### (1) Binding Resin

Preferable examples of a binding resin used in the toner particle, although not particularly limited, include thermoplastic resins such as a styrene resin, an acrylic resin, a styrene-acryl copolymer, a polyethylene resin, a polypropylene resin, a vinyl chloride resin, a polyester resin, a polyamide resin, a polyurethane resin, a polyvinyl alcohol resin, a vinyl ether resin, a N-vinyl resin and a styrene-butadiene resin.

### (2) Wax

In order to obtain the fixability and offset property in the toner, waxes can be preferably added.

The kind of the waxes is not particularly restricted. Examples thereof include polyethylene wax, polypropylene wax, fluororesin wax, Fisher-Tropsh wax, paraffin wax, ester wax, montan wax and rice wax, which may be used singularly or in a combination of at least two kinds thereof.

### (3) Charge Control Agent

From viewpoints of remarkably improving the charge level and charge rise characteristics (index to charge to a constant charge level in a short time) and obtaining excellent characteristics in the endurance and the stability in the toner, a charge control agent can be preferably added.

The kind of the charge control agent is not particularly limited, and preferable examples thereof include the charge control agents showing the positive chargeability such as nigrosin, a quaternary ammonium chloride compound and a resin type charge control agent obtained by bonding an amine compound to a resin.

### (4) Magnetic Powder and Carrier

As a magnetic powder or carrier, known ones can be used.

Examples thereof include ferromagnetic metals or alloys such as ferrite, magnetite, iron, cobalt and nickel or compounds containing the ferromagnetic elements, or alloys containing no ferromagnetic element but showing the ferromagnetism after appropriate heat treatment.

### (5) Additive

(5)-1 Titanium Oxide

In the toner, a titanium oxide can be preferably used as an additive.

This is because when the titanium oxide is used as an additive, the rotation member can more effectively polish the photoconductor drum. Accordingly, even when image formation is repeated, the surface of the photoconductor drum can be maintained in an excellent state.

This is also because, when, in the cleaning device, an abundance ratio of the titanium oxide as the additive and the toner particles is controlled, the air gap can be effectively prevented from occurring. More specifically, that is because, when a ratio of fluorescent X-ray intensities of titanium oxides in the toners before use and in the cleaning device is set in a predetermined range, the air gap can be effectively prevented from occurring to thereby effectively inhibit occurrence of the black spots caused by the leakage current from the cleaning device.

Furthermore, an average particle diameter of the titanium oxide is preferably set to a value in the range of 0.01 to 0.50 μm.

This because when the average particle diameter of titanium oxide is below 0.01 μm, uniform polishing is difficult to be effectively shown and in some cases, the charging up is caused and the image deletion at high temperature and high moisture is caused to result in image defect, while on the other hand, when the average particle diameter of titanium oxide is above 0.50 μm, the fluctuation in the charging amount in the toner becomes larger to, in some cases, result in lowering the image density and deteriorating the endurance.

Accordingly, the average particle diameter of a titanium oxide is set preferably to a value in the range of 0.02 to 0.4 μm and more preferably to a value in the range of 0.05 to 0.3 μm.

The average particle diameter of titanium oxide can be measured by a combination of an electron microscope and an image analyzer. That is, with a magnification ratio preferably set in the range of 30,000 to 100,000 times and by using an electron microscope JSM-880 (manufactured by JOEL Ltd.,), a major axis and a minor axis are measured of 50 particles, followed by calculating averages thereof by using an image analyzer.

Furthermore, the specific resistance of a titanium oxide is preferably set to a value in the range of 1×10⁰ to 1×10² Ω·cm and more preferably set to a value in the range of 1×100 to 5×100 Ω·cm.

This is because the toner in the cleaning device can effectively gradually release stored charges through titanium oxide having such a low specific resistance, with result of effectively suppressing the toner in the cleaning device from excessively charging.

This makes it possible to suppress the leakage current from the toner in the cleaning device to the photoconductor drum from occurring and to effectively inhibit the black spots caused by the leakage current from occurring.

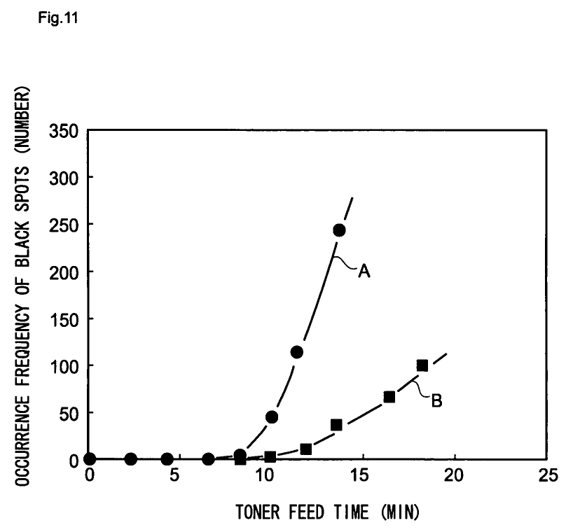

Next, the relationship between the specific resistance of titanium oxide and the occurrence frequency of black spots will be specifically described with reference to FIG. 11.

FIG. 11 shows characteristic curves A and B with the abscissa indicating a toner feed time (min) and the ordinate indicating the occurrence frequency of black spots (number) when an accelerated test is carried out. As the conditions of the accelerated test, the specific resistances of titanium oxides as the additive in the toner being used were respectively varied as shown below, and other conditions were set similarly to that described in the description of FIG. 5. As the elastic layer of the rotation member in the cleaning device, used was an elastic layer mainly made of EPDM and having the resistance of 1.35×10⁶Ω.

Results of the accelerated test like this are separately confirmed to be correlated with the occurrence frequency of the black spots under actual image forming conditions.

Here, the characteristic curve A corresponds to a case where titanium oxide having a medium specific resistance (8×10² Ω·cm) is added as the additive so as to be 1.5% by weight to a total amount of the toner. The characteristic curve B corresponds to a case where titanium oxide having a low specific resistance (1×10² Ω·cm) is added as the additive so as to be 1.5% by weight to a total amount of the toner.

In the characteristic curve A, the black spots start occurring from around a time when the toner feed time (min) passes 8 min, and thereafter keep on abruptly increasing in the occurrence frequency thereof (number). Around a time when the toner feed time (min) passes 15 min, the occurrence frequency of the black spots (number) increases up to substantially 300.

On the other hand, in the characteristic curve B, the black spots start occurring from around a time when the toner feed time (min) passes 8 min. Thereafter, until a time when the toner feed time (min) passes 13 min, the occurrence frequency of the black spots remains there without substantially increasing. Subsequently, from around a time when the toner feed time (min) passes 13 min, the occurrence frequency of the black spots (number) start increasing at a substantially constant rate. However, the occurrence frequency of the black spots (number) is suppressed to substantially 120 even around a time when the toner feed time (min) passes 20 min.

Accordingly, it is found that, in the accelerated test, the occurrence frequency of the black spots can be effectively suppressed when the specific resistance of titanium oxide as the additive is set to a value in the range of 1×10⁰ to 1×10² Ω·cm.

Furthermore, when the specific resistance of titanium oxide is set to a value in the range of 1×10⁰ to 1×10² Ω·cm, it is easy to control the content of titanium oxide in the toner in the cleaning device, with the result that a relational expression (1) described below can be readily satisfied. This results in more effectively inhibiting the toner in the cleaning device from excessively charging.

That is, since the charging properties of titanium oxide can be varied when the specific resistance of titanium oxide is varied, a ratio of titanium oxide transferred together with toner particles to a transfer body can be controlled in the transfer step. This makes it possible to control a content of titanium oxide in the toner recovered in the cleaning device.

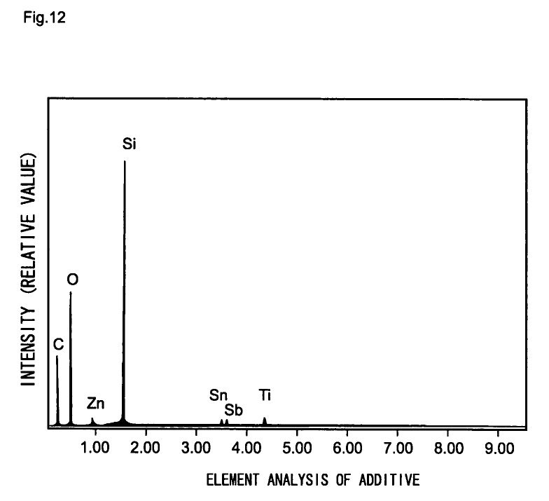

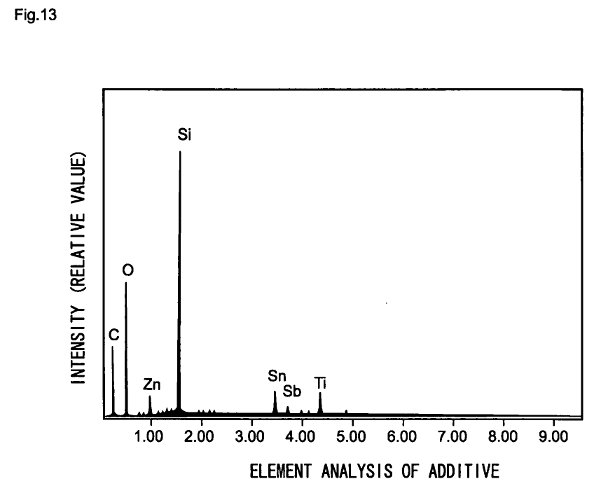

Then, with reference to FIGS. 12 and 13, an element analysis method that uses a fluorescence X-ray analyzer will be specifically described.

FIG. 12 shows results of the element analysis with a fluorescent X-ray analyzer in the toner in the cleaning device when titanium oxide having a medium specific resistance is used as the additive in the toner.

FIG. 13 shows results of the element analysis with a fluorescent X-ray analyzer in the toner in the cleaning device when titanium oxide having a low specific resistance is used as the additive in the toner.

It is understood from the two element analysis results, that, when the low specific resistance of the titanium oxide is used as the additive in the toner, the content of the titanium oxide in the toner in the cleaning device can be increased as compared with the case when the medium specific resistance of the titanium oxide is used.

Accordingly, it is found that the content of the titanium oxide in the toner in the cleaning device can be controlled by varying the specific resistance of the titanium oxide.

A measurement method that uses a fluorescent X-ray analyzer will be detailed in Example 1, and further, contents of the relational expression (1) associated with the fluorescent X-ray intensity will be specifically described in a later section of the toner characteristics.

An amount of the titanium oxide added is preferably set to a value in the range of 0.1 to 5 parts by weight with respect to 100 parts by weight of the toner particles.

This is because when the amount of the titanium oxide added is set to a value in the range of 0.1 to 5 parts by weight, the content of the titanium oxide in the toner in the cleaning device can be readily controlled, while the polishing effect to the photoconductor drum can be effectively exerted.

That is, this is because, when the addition amount is below 0.1 parts by weight, the content of the titanium oxide in the toner in the cleaning device becomes difficult to increase, whereby it may be difficult to control the content of the titanium oxide in the toner in the cleaning device to a preferable state that satisfies the relational expression (1) described below and to exert effectively the polishing effect, and in some cases, image quality under high temperature and high moisture conditions is remarkably deteriorated; while on the other hand, when the addition amount is above 5 parts by weight, the fluidity of the toner may be deteriorated.

Accordingly, an amount of the titanium oxide added is preferably set to a value in the range of 1 to 2 parts by weight and more preferably in the range of 1.2 to 1.6 parts by weight, with respect to 100 parts by weight of the toner particles.

### (5)-2 Silica Particles

As an additive to toner particles, silica particles (hereinafter, in some cases, referred to as agglomerated silica particles) are preferably added as an additive.

The silica particles preferably have a particle size distribution where a ratio of particles having a particle diameter of 5 μm or below is a value equal to 15% by weight or below to a total amount and a ratio of particles having a particle diameter of 50 μm or above is a value of 3% by weight or below.

This is because when a ratio of silica particles having a particle diameter of 5 μm or below is above 15% by weight, the silica particles tend to adhere to photoconductor particles to reflocculate and gather around silica particles relatively large in the particle diameter to be likely to generate the layer irregularity; while on the other hand, when a ratio of silica particles having a particle diameter of 50 μm or more is above 3% by weight, these collect silica particles relatively small in the particle diameter in the surrounding thereof to form largely flocculated silica particles to be likely to generate the layer irregularity as well.

Accordingly, in a more preferable particle size distribution of the silica particles, a ratio of particles having a particle diameter of 5 μm or below is set, relative to a total amount, to a value of 10% by weight or below and a ratio of particles having a particle diameter of 50 μm or above is set to a value of 2% by weight or below.

The particle size distribution of the silica particles can be measured by using a laser diffraction particle size analyzer LA-500 (trade name, manufactured by Horiba, Ltd.).

An amount of silica added is preferably set to a value in the range of 0.5 to 15.0 parts by weight with respect to 100 parts by weight of the toner particles.

This is because when an amount of the additive added is below 0.5 parts by weight, an improvement effect in the fluidity of the toner may be sufficiently exerted with difficulty, while on the other hand, when the amount of the additive added is above 15.0 parts by weight, a relational expression (2) described below may be satisfied with difficulty since an amount of silica added in the toner in the cleaning device becomes excessively large.

Accordingly, the amount of the additive added is set preferably to a value in the range of 0.7 to 10.0 parts by weight and more preferably to a value in the range of 0.9 to 5.0 parts by weight, with respect to 100 parts by weight of the toner particles.

### (6) Toner Characteristics

### (6)-1 Fluorescent X-Ray Intensity Ratio 1

In the image forming apparatus as the invention, when it is assume that a fluorescent X-ray intensity of the titanium oxide in a toner before use is X1 and a fluorescent X-ray intensity of the titanium oxide in the toner in the cleaning device is X2, the X1 and X2 preferably satisfy a relational expression (1) below.

X2/X1≧1.5 (1)

This is because, when a fluorescent X-ray intensity ratio of the titanium oxides in the toner before use and the toner in the cleaning device is set to a value in the range, the toner in the cleaning device can be prevented from excessively charging.

Accordingly, this is because the leakage current from the toner in the cleaning device to the photoconductor drum can be prevented from occurring, whereby the black spots generated owing to the leakage current can be effectively prevented from occurring.

That is, this is because when the value of X2/X1 is below 1.5, the content of the titanium oxide in the toner in the cleaning device becomes insufficient, and consequently an air gap described below is generated and the toner is excessively charged, so that in some cases, the leakage current tends to be generated.

On the other hand, when the content of the titanium oxide in the toner in the cleaning device becomes excessively large, the fluidity of the toner may be deteriorated or, owing to excessive polishing effect, the charging characteristics in the photoconductor drum may be locally much raised.

Accordingly, the X1 and X2 more preferably satisfy a relational expression (1′) below and more preferably further satisfy a relational expression (1″) below.

1.5≦X2/X1≦5 (1′)

1.8≦X2/X1≦4 (1″)

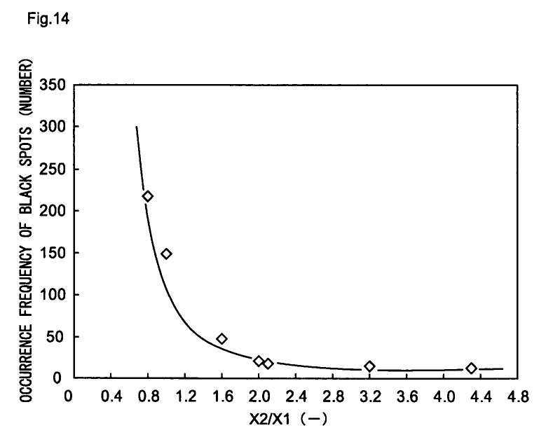

Next, a relationship between the ratio, X2/X1, and the occurrence frequency of the black spots will be specifically described with reference to FIG. 14.

In FIG. 14, the abscissa indicates a ratio of X2/X1 (−) and the ordinate indicates the occurrence frequency of the black spots (number) when an accelerated test is carried out. The conditions of the accelerated test are same as mentioned above.

Here, it is understood that, as the characteristic curve of FIG. 14 shows, the smaller the ratio of X2/X1 is, the more abundant the occurrence frequency of the black spots (number) in the accelerated test becomes. For example, when the ratio of X2/X1 is 0.8, the occurrence frequency of the black spots is above 200.

On the other hand, as the ratio of X2/X1 becomes larger, the occurrence frequency of the black spots (number) in the accelerated test decreases. Specifically, when the ratio of X2/X1 becomes 1.5 or above, the occurrence frequency of the black spots (number) in the accelerated test remarkably decreases.

Furthermore, as the ratio of X2/X1 becomes further larger, the occurrence frequency of the black spots (number) in the accelerated test further decreases, and the black spots are not substantially generated from around a ratio of X2/X1 that is above 2 in the accelerated test.

Accordingly, not only in the accelerated test but also in an actual image forming apparatus, it is assumed that, when the ratio of X2/X1 is set to a value equal to a predetermined value or above, the occurrence frequency of the black spots can be effectively suppressed.

(6)-2 Fluorescent X-Ray Intensity Ratio 2

When, in addition to the titanium oxide, silica is further contained as the additive and a fluorescent X-ray intensity of silica in the cleaning device is expressed with X3, the X2 (fluorescent X-ray intensity of the titanium oxide in the toner in the cleaning device) and X3 preferably satisfy a relational expression (2) below.

X3/X2≦20 (2)

This is because, when silica is used as an additive, the fluidity of the toner can be improved, with the result that, with a balance between the toner fluidity and the polishing properties excellently maintaining, the toner in the cleaning device can be effectively prevented from excessively charging.

That is, this is because when a value of (X3/X2) is above 20, the titanium oxides in an air gap are prevented from coming into contact with each other owing to an excessive amount of silica, whereby electric charges accumulated in the toner become difficult to be efficiently gradually released to a photoconductor drum.

On the other hand, when the content of silica in the toner in the cleaning device becomes excessively slight, the fluidity of the toner becomes difficult to improve in some cases.

Accordingly, the X2 and X3 are more preferred to satisfy a relational expression (2′) below and still more preferred to satisfy a relational expression (2″) below.

3≦X3/X2≦15 (2′)

5≦X3/X2≦10 (2″)

### EXAMPLES

Hereinbelow, the invention will be further detailed with reference to examples. It goes without saying that the following description exemplifies the invention and, without particular reasons, a range of the invention is not restricted by the following description.

### 1. Preparation of Rotation Member

### (1) Production of Rotation Member

In a vessel, added were 30 to 80 parts by weight of conductive carbon black, 30 to 80 parts by weight of paraffin oil, and as a foaming agent, 5 to 15 parts by weight of azodicarbodiamide with respect to 100 parts by weight of ethylene-propylene-diene rubber, followed by kneading. Then, the obtained mixture was molded in a tube by an extrusion molding method, followed by foaming and vulcanizing by using a microwave vulcanizing device (UHF), thereby to obtain 4 kinds of elastic layers A to D provided with the characteristics shown in Table 1, respectively.

Then, the obtained elastic layer was press-fitted to a cylindrical-shaped core metal (external diameter: 11 mm and length: 320 mm) which is made of iron and previously coated by an adhesive, followed by further adhering and vulcanizing. Subsequently, a surface of the elastic layer was polished to a film thickness of 1.5 mm to obtain a final rotation member.

The resistance, Asker C hardness and an average cell diameter in the elastic layer were measured respectively as follows.

### (2) Measurement of Resistance

The resistance of the formed elastic layer was measured.

That is, the obtained rotation member was press-fitted under pressure of 1 kgf (9.8 N) to a metal plate which is made of nickel-plated iron and has an area of 640 cm² (320 mm×200 mm), a thickness of 10 mm. Subsequently, with the metal plate and the core metal of the rotation member as electrodes, a voltage of 500 V was applied and a current value flowed at this time was measured. From the measurements, a resistance value of the elastic layer was calculated.

Here, based on the elastic layer A, the procedure for calculating the specific resistance of the elastic layer is explained.

As shown in Table 1, the resistance value of the elastic layer A was 1.3×10⁶Ω. The thickness of the elastic layer A was 1.5 mm, and the contact area between the elastic layer A and the metal plate was 20.2 cm².

Subsequently, by dividing the resistance value by the thickness of the elastic layer A, and multiplying the resultant value with the contact area, the specific resistance value is calculated to be 1.75×10⁸ Ω·cm².

In addition, the contact area between the elastic layer and the metal plate is approximately 20 cm² for the each of the elastic layer described above, when its thickness is 1.5 mm.

Therefore, the specific resistance of the elastic layer can be also calculated in the same manner.

### (3) Measurement of Asker C Hardness

The Asker C hardness of the formed elastic layer was measured.

That is, an Asker rubber hardness meter C type (manufactured by Kobunshi Keiki Co., Ltd.) was used to measure the hardness.

### (4) Measurement of Average Cell Diameter

The average cell diameter of foam cells was measured in the formed elastic layer.

First, a definition of the average cell diameter will be described. The average cell diameter is an average value of ones that are obtained by calculating cell diameters of all cells in terms of sphere-corresponding diameters. Further, such a method of calculating the cell diameter will be specifically described. For example, in the case of an elliptic cell, an average value of a major axis and a minor axis of the elliptic form is taken as a sphere-corresponding diameter.

A cell diameter before calculating in terms of corresponding sphere diameter is measured by observing a cross section of the elastic layer with a microscope.

### Example 1

### 1. Preparation of Toner

### (1) Preparation of Toner Particles

First, a plurality of polyester resins were used as a binder resin and a magnetic powder and the like were mixed therewith, followed by melting and kneading.

That is, by using a Henshel mixer, mixed were 100 parts by weight of a polyester resin (alcohol component: bisphenol A propionoxide adduct, acid component: terephthalic acid, Tg: 60° C., softening point: 150° C., acid value: 7.0, gel fraction: 30%), 3 parts by weight of CCA (trade name: Bontron No. 1, manufactured by Orient Chemical Industries, Ltd.) as a charge control agent, 3 parts by weight of a charge control resin (quaternary ammonium salt-added styrene-acryl copolymer, trade name: FCA196, manufactured by Fujikura Kasei K.K) and 3 parts by weight of ester wax (trade name: WEP-5, manufactured by Nippon Oil and Fats Co., Ltd.) as a wax component.

Next, a bi-axial extruder (cylinder setting temperature: 100° C.) was used to further knead the mixture, followed by coarsely pulverizing it by using a feather mill. Thereafter, the mixture was finely pulverized by a turbo-mill, followed by being classified by an air-flow type classifier, to obtain toner particles having an average particle diameter of 8.0 μm.

### (2) Addition of Additive

To 100 parts by weight of the obtained toner particles, mixed were 0.8 parts by weight of silica particles (trade name: RA200HS, manufactured by Nippon Aerosil Co., Ltd.) and 1.0 parts by weight of the titanium oxide (trade name: EC300, manufactured by TITAN KOGYO KABUSHIKI KAISHA) by a Henshel mixer, to obtain a toner. A specific resistance of the titanium oxide was 30 Ω·cm.

### 2. Fluorescent X-Ray Measurement

### (1) Fluorescent X-Ray Intensity of Titanium Oxide in Toner Before Use

A fluorescent X-ray intensity (X1) of the titanium oxide of the obtained toner was measured by a fluorescent X-ray analyzer.

That is, 5 g of the toner particles was molded into a disc-like pellet (diameter: 40 mm, thickness: 5 mm) by pressurizing at 20 MPa for 3 sec by a sample press-molding machine (trade name: BRE-32, manufactured by Maekawa testing Machine Co., Ltd.), followed by measuring fluorescent X-ray peak intensity (kcps) attributed to Ti contained in the toner by using a fluorescent X-ray analyzer (trade name: RIX200, manufactured by Rigaku Corp.) (voltage: 50 kV, current: 30 mA, X-ray tube: Rh).

### (2) Fluorescent X-Ray Intensity of Titanium Oxide in Toner in Cleaning Device

Further, a fluorescent X-ray intensity (X2) of the titanium oxide in the toner in the cleaning device was measured by a fluorescent X-ray analyzer.

That is, by using the obtained toner, KM-C3232 (trade name, manufactured by Kyocera-Mita Co., Ltd.) having a rotation member provided with the elastic layer A and A4-size papers, a predetermined image was continuously formed on 1000 sheets under the following conditions, followed by taking out the toner from the cleaning device of the image forming apparatus. A fluorescent X-ray intensity was measured by a fluorescent X-ray analyzer in the same manner as in the measurement of the fluorescent X-ray intensity in the toner before use, except that the toner was used.

When the fluorescent X-ray intensity is measured, the image forming conditions are set as follows.

### (Image Forming Conditions)

### Environment: 23° C. and 50% RH

### Original: original having 6%-density to the respective colors

Photoconductor: a-Si photoconductor (film thickness: 15 μm)
Drum circumferential speed: 150 mm/s
Printing speed: 32 sheets/min
Surface potential: 270 V

### (Charging Conditions)

AC bias: 1.2 kvpp
DC bias: 350 V

### (Cleaning Blade Conditions)

Blade hardness: 700 (JIS-A standard)

### Material: urethane

### Thickness: 2.2 mm

Projection length: 11 mm
Linear pressure: 22 g/cm
Press-contact angle: 25°

### (Rotation Member)

Elastic layer: Elastic layer A
Circumferential speed difference with drum: 1.2 times (rotation in a rotational direction to drum)

### (3) Fluorescent X-Ray Intensity of Silica in Toner in Cleaning Device

Furthermore, a fluorescent X-ray intensity (X3) of silica in the toner in the cleaning device was measured by a fluorescent X-ray analyzer.

That is, measurement was performed with a fluorescent X-ray analyzer in the same manner as in the measurement of the fluorescent X-ray intensity of the titanium oxide in the toner in the cleaning device.

### (4) Fluorescent X-Ray Intensity Ratio

Values of ratios (X2/X1) and (X3/X2) as the fluorescent X-ray intensity ratio, respectively, were calculated from the obtained X1 to X3. The obtained results are shown in Table 1.

### 3. Evaluation

### (1) Evaluation of Occurrence Frequency of Black Spots

With the obtained image forming apparatus, an image was formed and the occurrence frequency of the black spots was evaluated.

That is, after a predetermined image is continuously printed on 1,000 sheets with A4-size sheets under the foregoing conditions, a white-paper image (A4-size) was formed, and the occurrence frequency of the black spots in the white-paper image was measured to evaluate under criteria below. The obtained results are shown in Table 1.

Very good: the occurrence frequency of the black spots is below 20 points/A4-size paper

### Good: the occurrence frequency of the black spots is a value in the range of 20 to 50 points/A4-size paper

### Fair: the occurrence frequency of the black spots is a value in the range of 50 to 100 points/A4-size paper

### Bad: the occurrence frequency of the black spots is a value of 100 points/A4-size paper or more

### Example 2

In Example 2, a toner was prepared and evaluated in the same manner as in Example 1 except that when a toner was prepared, the content of the titanium oxide as an additive was changed to 0.8 parts by weight with respect to 100 parts by weight of toner particles. The obtained results are shown in Table 1.

### Example 3

In Example 3, a toner was prepared and evaluated in the same manner as in Example 1 except that when a toner was prepared, the content of the titanium oxide as an additive was changed to 1.5 parts by weight with respect to 100 parts by weight of toner particles. The obtained results are shown in Table 1.

### Example 4

In Example 4, a toner was prepared and evaluated in the same manner as in Example 1 except that when a toner was prepared, as an additive, the titanium oxide of which specific resistance was 10 Ω·cm (trade name: EC100, manufactured by TITAN KOGYO KABUSHIKI KAISHA) was used. The obtained results are shown in Table 1.

### Example 5

In Example 5, a toner was prepared and evaluated in the same manner as in Example 4 except that when a toner was prepared, a content of the titanium oxide as an additive was changed to 1.2 parts by weight with respect to 100 parts by weight of toner particles. The obtained results are shown in Table 1.

### Examples 6 to 10

In Examples 6 to 10, toners were prepared and evaluated in the same manner as in Examples 1 to 5, respectively, except that an elastic layer B was used as an elastic layer in a rotation member. The obtained results are shown in Table 1.

### Examples 11 to 15

In Examples 11 to 15, toners were prepared and evaluated in the same manner as in Examples 1 to 5, respectively, except that an elastic layer C was used as an elastic layer in a rotation member. The obtained results are shown in Table 1.

### Comparative Examples 1 to 3

In comparative Examples 1 to 3, toners were prepared and evaluated in the same manner as in Examples 1, 4 and 5, except that an elastic layer D was used as an elastic layer in a rotation member. The obtained results are shown in Table 1.

TABLE 1

| | | | | | | | | | | | Evaluation of occurrence | |
|---|---|---|---|---|---|---|---|---|---|---|---|---|
| | | | | | | | | | | | frequency of black spots | |
| | Elastic Member | | | | | | | | | | Occurrence | |
| | | Primary | | | Average | Titanium oxide | | | | | frequency of | |
| | | constit- | | Asker C | cell | Content | Specific | Content of | Fluorescent X-ray | | black spots | |
| | | uent | Resistance | hardness | diameter | (parts by | resistance | silica (parts | intensity ratio | | (number/A4- | |
| | Type | material | (Ω) | (degree) | (μm) | weight) | (Ω · cm) | by weight) | X2/X1 | X3/X2 | size paper) | Evaluation |
| Example 1 | A | EPDM | 1.3 × 10⁴ | 58 | 150 | 1.0 | 30.0 | 0.8 | 2.0 | 9.0 | 45 | Good |
| Example 2 | | | | | | 0.8 | 30.0 | 0.8 | 2.2 | 9.4 | 45 | Good |
| Example 3 | | | | | | 1.0 | 30.0 | 1.5 | 1.6 | 15.6 | 50 | Fair |
| Example 4 | | | | | | 1.0 | 10.0 | 0.8 | 3.4 | 8.4 | 31 | Good |
| Example 5 | | | | | | 1.2 | 10.0 | 0.8 | 4.1 | 7.6 | 28 | Good |
| Example 6 | B | EPDM | 1.3 × 10³ | 50 | 230 | 1.0 | 30.0 | 0.8 | 2.2 | 9.1 | 18 | Very good |
| Example 7 | | | | | | 0.8 | 30.0 | 0.8 | 1.9 | 10.1 | 17 | Very good |
| Example 8 | | | | | | 1.0 | 30.0 | 1.5 | 1.5 | 15.3 | 15 | Very good |
| Example 9 | | | | | | 1.0 | 10.0 | 0.8 | 3.4 | 8.4 | 14 | Very good |
| Example 10 | | | | | | 1.2 | 10.0 | 0.8 | 4.1 | 7.6 | 13 | Very good |
| Example 11 | C | EPDM | 1.4 × 10⁴ | 55 | 120 | 1.0 | 30.0 | 0.8 | 2.1 | 9.2 | 17 | Very good |
| Example 12 | | | | | | 0.8 | 30.0 | 0.8 | 2.0 | 9.8 | 21 | Good |
| Example 13 | | | | | | 1.0 | 30.0 | 1.5 | 1.6 | 15.1 | 22 | Good |
| Example 14 | | | | | | 1.0 | 10.0 | 0.8 | 3.2 | 8.5 | 15 | Very good |
| Example 15 | | | | | | 1.2 | 10.0 | 0.8 | 4.3 | 7.9 | 13 | Very good |
| Comparative | D | EPDM | 1.5 × 10⁸ | 60 | 180 | 1.0 | 30.0 | 0.8 | 1.2 | 18.3 | 125 | Bad |
| Example 1 | | | | | | | | | | | | |
| Comparative | | | | | | 1.0 | 10.0 | 0.8 | 1.4 | 14.2 | 120 | Bad |
| Example 2 | | | | | | | | | | | | |
| Comparative | | | | | | 1.2 | 10.0 | 0.8 | 1.4 | 16.3 | 111 | Bad |
| Example 3 | | | | | | | | | | | | |

### INDUSTRIAL APPLICABILITY

According to the image forming apparatus based on the invention and the image forming method therewith provide the following advantage. That is, even in the case of adopting a downward transfer process, excessive charging in a toner in a cleaning device and an air gap can be effectively prevented from occurring, by using a rotation member provided with an elastic layer having a predetermined resistance. As a result, it becomes possible to effectively suppress occurrence of the black spots owing to the leakage current from the cleaning device.

Accordingly, an image forming apparatus based on the invention and the image forming method therewith are expected to largely contribute to an improvement of the image characteristics in various kinds of image forming apparatuses such as a copying machine and a printer.

What is claimed is:

1. An image forming apparatus comprising:
a latent image carrier for transferring a toner carried on a surface thereof from downward to a transfer body; and
a cleaning device provided with a rotation member for cleaning the surface of the latent image carrier, wherein
a resistance of an elastic layer formed on an outer periphery part of the rotation member is set to a value in the range of 1×10² to 1×10⁷Ω.

2. The image forming apparatus according to claim 1, wherein the toner includes a titanium oxide as an additive, and assuming that a fluorescent X-ray intensity of the titanium oxide of the toner before use is X1 and a fluorescent X-ray intensity of the titanium oxide of the toner in the cleaning device is X2, the X1 and X2 satisfy a relational expression (1) below.
X2/X1≧1.5 (1)

3. The image forming apparatus according to claim 1, wherein a principal constituent material of the elastic layer in the rotation member is at least one kind selected from the group consisting of ethylene-propylene-diene rubber, ethylene-propylene rubber, urethane rubber, silicone rubber, acrylic rubber and nitrile rubber.

4. The image forming apparatus according to claim 1, wherein the elastic layer in the rotation member is formed of a resin foam and an average cell diameter in the resin foam is set to a value in the range of 100 to 300 μm.

5. The image forming apparatus according to claim 1, wherein an Asker C hardness of the elastic layer in the rotation member is set to a value in the range of 30 to 65 degree.

6. The image forming apparatus according to claim 1, wherein the rotation member is grounded.

7. The image forming apparatus according to claim 2, wherein a specific resistance of the titanium oxide is set to a value in the range of 1×10⁰ to 1×10² Ω·cm.

8. The image forming apparatus according to claim 1, wherein the cleaning device has a toner receiving member for storing the toner scraped off the latent image carrier.

9. An image forming method comprising the steps of:
transferring a toner carried on a surface of a latent image carrier from downward to a transfer body; and
cleaning the surface of the latent image carrier by using a cleaning device provided with a rotation member for cleaning the surface of the latent image carrier, wherein
a resistance of an elastic layer formed on an outer periphery part of the rotation member is set to a value in the range of 1×10² to 1×10⁷Ω.
